(19) United States
(12) Patent Application Publication
(10) Pub. No.: US 2026/0110144 A1
(43) Pub. Date: Apr. 23, 2026

(54) TRANSFER DEVICE

(71) Applicant: Pulpex Limited, Sawston (GB)

(72) Inventor: Robert Cecil BEESLEY, Greenville, SC (US)

(21) Appl. No.: 19/412,630

(22) Filed: Dec. 8, 2025

Related U.S. Application Data
(63) Continuation of application No. PCT/GB2024/051631, filed on Jun. 26, 2024.

(30) Foreign Application Priority Data
Jun. 29, 2023 (GB) 2309880.9

(51) Int. Cl. D21J 5/00

(52) U.S. Cl. CPC D21J 5/00

(57) ABSTRACT

A hollow moulded fibre product manufacturing system comprises: (i) a plurality of first mould cavities configured to receive a fibre suspension for forming respective partially formed hollow moulded fibre products therein, (ii) a plurality of second mould cavities configured to receive the respective partially formed hollow moulded fibre products from the plurality of first mould cavities for further processing the respective partially formed hollow moulded fibre products in the plurality of second mould cavities to provide hollow moulded fibre products. A total number of the second mould cavities is greater than or equal to a total number of the first mould cavities. The system further comprises: (iii) a transfer device configured to transfer the partially formed hollow moulded fibre products from the plurality of first mould cavities to the plurality of second mould cavities.

### CROSS-REFERENCE TO RELATED APPLICATIONS

This application is a continuation under 35 U.S.C. § 120 of International Application No. PCT/GB2024/051631, filed Jun. 26, 2024, which claims priority to United Kingdom Application No. GB 2309880.9, filed Jun. 29, 2023, under 35 U.S.C. § 119(a). Each of the above-referenced patent applications is incorporated by reference in its entirety.

### TECHNICAL FIELD

The present invention relates to hollow moulded fibre product manufacturing systems, where hollow moulded fibre products are formed from a fibre suspension, such as a fibre suspension comprising paper pulp. The hollow moulded fibre products may be, or may be precursors of, receptacles that may form consumer packaging, such as bottles, useful for holding liquids, powders, other flowable materials or solid objects.

### BACKGROUND

Bottles made from a fibre suspension are known and may be used in place of plastic bottles. These pulp-moulded bottles can therefore reduce the amount of plastic used in disposable consumer goods.

Published patent document EP1195466 describes forming a pulp moulded article. In a first step, a precursor (a “partially formed” pulp moulded article) is formed in a first mould. To achieve this, a fibre suspension (pulp slurry) is introduced into a mould cavity of the first mould and “dewatered” using a vacuum and an inflatable pressing member (such as a bladder). The pressing member is introduced into the first mould and is expanded to press the fibre suspension against the inside of the mould cavity. After being dewatered, the precursor is removed from the first mould and is subjected to a drying process. In this drying process, the precursor is introduced into a mould cavity of a second (heated) mould where another inflatable pressing member is used to press the precursor against the inside of the heated mould cavity. The article is therefore formed in the second mould.

### SUMMARY

As mentioned, it is known to use two moulds to form a pulp moulded article (referred to herein, amongst other things, as a hollow moulded fibre product). As the use of such pulp moulded products becomes more ubiquitous, the process for manufacturing such products must become more efficient and streamlined. However, due to the delicate nature of the partially formed products (i.e., those formed in the first (primary) mould), it is also important to ensure that the partially formed products are handled with care.

Accordingly, described herein are hollow moulded fibre product manufacturing systems and methods that provide a more efficient way of manufacturing such hollow moulded fibre products, while also reducing the risk of damage to the products, thereby resulting in a high manufacturing yield.

In any of the examples described herein, the product may be referred to as a necked product. For example, a hollow moulded fibre product may be a necked hollow moulded fibre product and a partially formed hollow moulded fibre product may be a partially formed necked hollow moulded fibre product A necked product is a product having a neck, such as the neck of a bottle. A hollow product is a product that has an empty space or void inside. A moulded product is a product that is made within a mould. A fibre product is one that is formed from a fibre suspension, such as a fibre suspension comprising paper pulp.

According to a first aspect of the present invention, there is provided a hollow moulded fibre product manufacturing system, comprising: (i) a plurality of first mould cavities configured to receive a fibre suspension for forming respective partially formed hollow moulded fibre products therein, (ii) a plurality of second mould cavities configured to receive the respective partially formed hollow moulded fibre products from the plurality of first mould cavities for further processing the respective partially formed hollow moulded fibre products in the plurality of second mould cavities to provide hollow moulded fibre products, wherein a total number of the second mould cavities is greater than or equal to a total number of the first mould cavities, and (iii) a transfer device configured to transfer the partially formed hollow moulded fibre products from the plurality of first mould cavities to the plurality of second mould cavities. As mentioned, in examples, the products may be necked, and the hollow moulded fibre product manufacturing system may therefore be a necked hollow moulded fibre product manufacturing system.

Such a system provides an efficient way of manufacturing hollow moulded fibre products by ensuring that there are sufficient second mould cavities to receive partially formed products from the first mould cavities. The transfer device provides an effective way of transferring products between the moulds without requiring human intervention. An automated transfer device can also ensure that each partially formed product is handled with care, to avoid damaging the product.

In certain examples, the (partially formed) hollow moulded fibre product may be known as a (partially formed) receptacle, a (partially formed) article, a (partially formed) bottle, a (partially formed) container, a (partially formed) receptacle for containing fluid (such as a liquid) or solids (such as pharmaceutical or other tablets/capsules), a (partially formed) article for containing fluid, a (partially formed) bottle for containing fluid, a (partially formed) container for containing fluid, etc. A partially formed hollow moulded fibre product may be moulded from a fibre suspension, including constituents such as paper pulp. A fibre suspension may contain, amongst other things, cellulose fibres and a liquid, such as water. Additives may be present in the fibre suspension.

The (partially formed) hollow moulded fibre product may have a longitudinal axis along its length. The length/height of the (partially formed) hollow moulded fibre product may be greater than a width and/or depth of the (partially formed) hollow moulded fibre product. In some examples, the (partially formed) hollow moulded fibre product may have a generally circular footprint owing to a generally cylindrical form of the (partially formed) hollow moulded fibre product (at least along a portion of its length). In some examples, the (partially formed) hollow moulded fibre product may have a footprint that is square or squircular.

In examples, a first mould comprises a first mould cavity. As such, the system may comprise a plurality of first moulds, each first mould comprising a first mould cavity configured to receive the fibre suspension. Similarly, in examples, a second mould comprises a second mould cavity. As such, the system may comprise a plurality of second moulds, each second mould comprising a second mould cavity configured to receive a partially formed hollow moulded fibre product.

Each of the first moulds therefore defines a cavity (also known as a “mould cavity”) therein, and a layer or coating of the fibre suspension can be applied to an inner wall of the mould (the “mould cavity wall”). This initial layer/coating may have a first thickness, and after being compressed by either an inflatable member or a high pressure fluid (such as air), the layer may have a second thickness that is less than the first thickness owing to the compaction of the fibres and removal of some of the liquid.

In certain examples, each first mould has an opening into the first mould cavity, through which the fibre suspension may be supplied. In some examples, the first mould cavity has a main body portion (also known as a first portion) and a neck portion (also known as a second portion). Both portions of the cavity together form the first mould cavity. The neck portion may be used to form the neck of the hollow moulded fibre product. A lid/cap may be applied to an end of the neck of the hollow moulded fibre product, for example. In some examples, the main body portion has a cross-sectional width that is larger than the cross-sectional width of the neck portion (the cross-section being taken in a plane parallel to a longitudinal axis of the receptacle).

In some examples, the first mould cavities each have apertures formed on/through the mould cavity walls. This allows liquid to pass from within the cavity to outside of the mould. The apertures may therefore extend from the cavity to an outer surface of the mould.

In examples, the plurality of first mould cavities form a first moulding station and the plurality of second mould cavities form a second moulding station.

In examples, the further processing the respective partially formed hollow moulded fibre products comprises thermoforming the respective partially formed products by the application of heat and pressure.

In examples, transferring/moving the partially formed products to the plurality of second mould cavities comprises depositing the partially formed products directly into the second mould cavities. In other examples, transferring/moving the partially formed products to the second mould cavities comprises transferring/moving the partially formed products to a location in the vicinity of the second mould cavities, before one or more external forces (such as via a positive pressure and/or a vacuum) causes the partially formed products to be deposited directly into the second mould cavities.

In certain examples, the total number of the second mould cavities is greater than the total number of the first mould cavities. It has been found that the processing in the second mould cavities generally takes longer than the processing in the first mould cavities, so providing more second mould cavities allows partially formed products to be transferred into the second mould cavities when they are ready, thereby increasing productivity and efficiency. That is, a first batch of one or more products can be formed in the first mould cavities, transferred to the second mould cavities, and while being processed in the second mould cavities, a further batch of one or more products can be formed in the first mould cavities and transferred into the available second mould cavities. In addition, having a greater number of second mould cavities can mean that at a particular instance in time, at least one of the second mould cavities will be empty, allowing the mould to be cleaned, if required.

In a particular example, the total number of the second mould cavities is an integer multiple of the total number of the first mould cavities. Having an integer multiple provides a way to transfer all the partially formed products formed in the first mould cavities to the second mould cavities, while ensuring that the number of available second mould cavities is great enough to receive a second batch of all the partially formed products formed in the first mould cavities. This again increases productivity and efficiency.

In some examples, the integer multiple is based on the time taken to form the partially formed hollow moulded fibre products in the plurality of first mould cavities relative to the time taken to form the hollow moulded fibre products in the plurality of second mould cavities.

In a particular example, the total number of the second mould cavities is twice the total number of the first mould cavities. It has been found that in some examples, the processing in the second mould cavities takes approximately twice as long as the processing in the first mould cavities, so providing twice the number of second mould cavities allows two batches of partially formed products to be transferred into the second mould cavities at different times. That is, a first batch of products can be formed in the first mould cavities, transferred to the second mould cavities, and while those are being processed in the second mould cavities, a further batch of products can be formed in the first mould cavities and transferred into the available second mould cavities. Having twice the number of second mould cavities means that as the moulding in the first mould cavities completes, there are always available second mould cavities to receive the partially formed products.

As such, in some examples, the time taken to form the partially formed hollow moulded fibre products in the plurality of first mould cavities is approximately half the time taken to form the hollow moulded fibre products in the plurality of second mould cavities.

In certain examples, the transfer device can carry/transfer multiple partially formed products at once. That is, the transfer device is configured to simultaneously transfer two or more partially formed hollow moulded fibre products from the plurality of first mould cavities to the plurality of second mould cavities. Providing a transfer device that can simultaneously transfer two or more partially formed hollow moulded fibre products improves productivity and increases output by the manufacturing system by reducing the amount of transfer operations by the transfer device.

In certain arrangements, the transfer device is configured to simultaneously transfer all the partially formed hollow moulded fibre products from the plurality of first mould cavities to the plurality of second mould cavities. Moving all of the partially formed hollow moulded fibre products formed in the plurality of first mould cavities at once simplifies operations by reducing the number of transfers required, and allows further products to be formed in the (then empty) first mould cavities. In a particular example, there are four first mould cavities and the transfer device can simultaneously transfer four partially formed products from the four first mould cavities into the second mould cavities.

In one example, the total number of the second mould cavities is greater than the total number of the first mould cavities and the transfer device is configured to transfer two or more partially formed hollow moulded fibre products from the plurality of first mould cavities to a subset of the plurality of second mould cavities. Transferring the partially formed products in batches ensures that productivity is maximised, without having to wait for any of the processes to complete. It also ensures that the remaining (unoccupied) second mould cavities are available for cleaning, if required. More particularly, in some examples, the transfer device is configured to transfer all the partially formed hollow moulded fibre products from the plurality of first mould cavities to the subset of the plurality of second mould cavities.

In further examples, the subset is a first subset, and the transfer device is configured to: (i) transfer two or more partially formed hollow moulded fibre products from the plurality of first mould cavities to the first subset of the plurality of second mould cavities at a first time, and (ii) transfer two or more further partially formed hollow moulded fibre products from the plurality of first mould cavities to a second subset of the plurality of second mould cavities at a second time. Transferring the partially formed products in batches ensures that productivity is maximised. After the first batch of partially formed products has been transferred at the first time, a second batch can be formed in the first mould cavities. These can be transferred at the second time.

In certain examples, the two or more further partially formed hollow moulded fibre products transferred at the second time were formed in the plurality of first mould cavities after the two or more partially formed hollow moulded fibre products transferred at the first time were formed. Put another way, the two or more further partially formed hollow moulded fibre products transferred at the second time were formed in the same plurality of first mould cavities as the two or more partially formed hollow moulded fibre products transferred at the first time.

In a particular example, the subset is a first subset, and the transfer device is configured to: (i) transfer all the partially formed hollow moulded fibre products from the plurality of first mould cavities to the first subset of the plurality of second mould cavities at a first time, and (ii) transfer all of a further plurality of partially formed hollow moulded fibre products from the plurality of first mould cavities to a second subset of the plurality of second mould cavities at a second time. Moving all of the partially formed hollow moulded fibre products formed in the plurality of first mould cavities at once simplifies operations by reducing the number of transfers required, and allows further products to be formed in the (then empty) first mould cavities.

In certain examples, the further plurality of partially formed hollow moulded fibre products transferred at the second time was/were formed in the plurality of first mould cavities after the partially formed hollow moulded fibre products transferred at the first time were formed. Put another way, the further plurality of partially formed hollow moulded fibre products transferred at the second time was/were formed in the same plurality of first mould cavities as the partially formed hollow moulded fibre products transferred at the first time.

In one example, the transfer device is configured to alternate between transferring all the partially formed hollow moulded fibre products from the plurality of first mould cavities to the first and second subsets of the plurality of second mould cavities.

In a particular example, there are four first mould cavities and eight second mould cavities, and the transfer device simultaneously transfers all four partially formed products from the four first mould cavities into four of the second mould cavities at a first time (i.e., once the four partially formed products are formed). Once the first mould cavities are empty, a further four partially formed products may be formed in the first mould cavities. At a second time, the transfer device simultaneously transfers all four further partially formed products from the four first mould cavities into the remaining four second mould cavities (i.e., once the further four partially formed products are formed).

In certain arrangements, the transfer device comprises one or more vacuum contact surfaces to contact one or more partially formed hollow moulded fibre products as the one or more partially formed hollow moulded fibre products are being transferred from the plurality of first mould cavities to the plurality of second mould cavities, and the transfer device is configured to apply a vacuum to hold the one or more partially formed hollow moulded fibre products on the one or more vacuum contact surfaces as the one or more partially formed hollow moulded fibre products are being transferred from the plurality of first mould cavities to the plurality of second mould cavities. A vacuum contact surface provides a delicate yet precise way to transfer the partially formed products between the mould cavities. The use of suction means that gripping or grabbing devices are not needed, which could otherwise damage the partially formed products. A vacuum contact surface is configured to retain a partially formed hollow moulded fibre product against the vacuum contact surface using suction.

In a particular example, there is a vacuum contact surface for each partially formed product being transferred. For example, the transfer device may comprise two or more vacuum contact surfaces, each of the vacuum contact surfaces being configured to contact a respective partially formed hollow moulded fibre product, the transfer device being configured to simultaneously transfer two or more partially formed hollow moulded fibre products from the plurality of first mould cavities to the plurality of second mould cavities. The use of individual vacuum contact surfaces provides a tailored way of supporting and securing each partially formed product.

In other examples, a vacuum contact surface may hold a plurality of partially formed products.

In one arrangement, the plurality of first mould cavities is/are aligned along a first axis, the plurality of second mould cavities is/are aligned along a second axis, and the transfer device is configured to simultaneously transfer two or more partially formed hollow moulded fibre products from the plurality of first mould cavities to the plurality of second mould cavities, wherein in use, the two or more partially formed hollow moulded fibre products are aligned along a third axis on the transfer device, the third axis being moveable relative to the first and second axes to be coincident with the first and second axes. Aligning the first and second mould cavities along axes, along with the partially formed products on the transfer devices, simplifies the transfer because the partially formed products can be collected by the transfer device from the first mould cavities and deposited in the plurality of second mould cavities, without requiring the relative positions of the partially formed products to be adjusted during transfer. In an example, the first and second axis may be arranged such that an angle subtends between the axes. In one particular example, the first and second axes may be perpendicular to each other. The transfer device can move the third axis such that it is coincident with any one of the first and second axes.

In some arrangements, a spacing between the first mould cavities corresponds to a spacing between the second mould cavities. Similarly, in some examples, the spacings also correspond to spacings between the two or more partially formed hollow moulded fibre products on the transfer device.

In a particular example, the plurality of first mould cavities and the plurality of second mould cavities are coaxial. Aligning the plurality of first mould cavities and the plurality of second mould cavities along the same axis allows one side of the mould cavities to be accessed by a human operator, for inspection and maintenance. The transfer device can be located on the other side of the cavities. This means that the plurality of first mould cavities and the plurality of second mould cavities may be aligned along a common axis, the common axis comprising the first and second axes. Put another way, the plurality of first mould cavities and the plurality of second mould cavities are aligned along a common axis.

In some examples, the system further comprises a second transfer device configured to transfer the hollow moulded fibre products from the plurality of second mould cavities to a further location. Use of a second transfer device means that the first transfer device remains free to transfer partially formed products between the first and second mould cavities. Use of two transfer devices means that each transfer device can operate in a more limited area of the manufacturing facility, simplifying the movement range and complexity of each transfer device. In an example, the further location is a moving surface, such as a conveyor belt.

According to a second aspect of the present invention there is provided a receptacle manufacturing line comprising the hollow moulded fibre product manufacturing system of the first aspect and apparatus for performing at least one additional process on at least one of the hollow moulded fibre products to provide a receptacle. In some examples, the receptacle manufacturing line comprises two or more of the manufacturing systems of the first aspect.

In examples, the apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, and in any of the examples described herein, the receptacle is a bottle, jar or a type of vase. In a particular example, the receptacle is a bottle.

According to a third aspect of the present invention there is provided a method, comprising: (i) at a first time, simultaneously transferring two or more partially formed hollow moulded fibre products from respective first mould cavities of a plurality of first mould cavities to a first subset of a plurality of second mould cavities using a transfer device, and (ii) at a second time, simultaneously transferring two or more further partially formed hollow moulded fibre products from respective first mould cavities of the plurality of first mould cavities to a second subset of the plurality of second mould cavities using the transfer device. The plurality of first mould cavities is/are configured to receive a fibre suspension for forming respective partially formed hollow moulded fibre products therein, the plurality of second mould cavities is/are configured to receive respective partially formed hollow moulded fibre products from the plurality of first mould cavities for further processing the partially formed hollow moulded fibre products in the plurality of second mould cavities to provide hollow moulded fibre products, and a total number of the second mould cavities is greater than a total number of the first mould cavities.

The two or more partially formed hollow moulded fibre products transferred at the second time are different to those transferred at the first time. The two or more partially formed hollow moulded fibre products transferred at the second time are two or more further partially formed hollow moulded fibre products.

In certain examples, the method is a method of manufacture. In certain examples, the method is a method of transferring partially formed hollow moulded fibre products.

In a particular example, the method comprises, at the first time, simultaneously transferring all of a plurality of partially formed hollow moulded fibre products from the plurality of first mould cavities to the first subset of the plurality of second mould cavities using the transfer device, and at the second time, simultaneously transferring all of a further plurality of partially formed hollow moulded fibre products from the plurality of first mould cavities to the second subset of the plurality of second mould cavities using the transfer device.

In examples, the transfer device comprises two or more vacuum contact surfaces to contact the two or more partially formed hollow moulded fibre products as they are being transferred from the plurality of first mould cavities to the plurality of second mould cavities, and the method comprises, at the first time: (i) moving the two or more vacuum contact surfaces of the transfer device towards the two or more partially formed hollow moulded fibre products within respective first mould cavities of the plurality of first mould cavities, (ii) applying a vacuum to the two or more vacuum contact surfaces to hold the two or more partially formed hollow moulded fibre products on the two or more vacuum contact surfaces, (iii) moving the two or more vacuum contact surfaces relative to the plurality of first mould cavities, such that the transfer device carries the two or more partially formed hollow moulded fibre products, and (iv) depositing the two or more partially formed hollow moulded fibre products in respective second mould cavities of the plurality of second mould cavities.

In examples, steps (i)-(iv) are also performed at the second time on the two or more further partially formed hollow moulded fibre products.

In an example, depositing the two or more partially formed hollow moulded fibre products in respective second mould cavities of the plurality of second mould cavities comprises removing or reducing the vacuum from the two or more vacuum contact surfaces, or applying a positive pressure to the two or more partially formed hollow moulded fibre products, to transfer the two or more partially formed hollow moulded fibre products to the respective second mould cavities of the plurality of second mould cavities. Applying a positive pressure means that air is blown from the vacuum contact surface to urge the partially formed product away from the vacuum contact surface.

In some arrangements the method comprises: (i) providing the plurality of first mould cavities, the plurality of first mould cavities being aligned along a first axis, (ii) providing the plurality of second mould cavities, the plurality of second mould cavities being aligned along a second axis, (iii) providing the transfer device, the transfer device being configured to transfer the two or more partially formed hollow moulded fibre products from the plurality of first mould cavities to the plurality of second mould cavities while the two or more partially formed hollow moulded fibre products are aligned along a third axis on the transfer device, and (iv) at both the first and second times, moving the transfer device from a first position in which the third axis is coincident with the first axis, to a second position in which the third axis is coincident with the second axis.

In some examples, the method comprises providing a second transfer device, the second transfer device being configured to transfer two or more hollow moulded fibre products from the plurality of second mould cavities to a further location.

In some examples, the method comprises transferring a hollow moulded fibre product from a second mould cavity of the plurality of second mould cavities to a further location using a second transfer device. In a specific example, the second transfer device is configured to simultaneously transfer all the products in the first or second subsets of the second mould cavities at one time.

In some examples, the method comprises after the first time and before the second time, determining that the two or more partially formed hollow moulded fibre products from respective first mould cavities of a plurality of first mould cavities are ready to be transferred to the second subset of the plurality of second mould cavities.

For example, a control system may transmit a signal to the transfer device to notify the transfer device that it is ready to collect/transfer the partially formed products.

In examples, the method comprises alternating between transferring two or more partially formed hollow moulded fibre products to the first and second subsets of the plurality of second mould cavities using the transfer device. Alternating between the first and second subsets of second mould cavities ensures that the remaining (unoccupied) second mould cavities are available for cleaning, if required.

According to a fourth aspect of the present invention there is provided a hollow-moulded-fibre-product-manufacturing-system controller configured to cause a hollow moulded fibre product manufacturing system to perform the method of the third aspect. In examples, the hollow-moulded-fibre-product-manufacturing-system controller is or comprises a processor.

According to a fifth aspect of the present invention there is provided a non-transitory storage medium storing machine-readable instructions that, when executed by a hollow-moulded-fibre-product-manufacturing-system controller, cause a hollow moulded fibre product manufacturing system to perform the method of the third aspect. In some examples, there is provided a storage medium storing machine-readable instructions that, when executed by a hollow-moulded-fibre-product-manufacturing-system controller, cause a hollow moulded fibre product manufacturing system to perform the method of the third aspect.

According to a sixth aspect of the present invention there is provided a method of manufacturing a receptacle, the method comprising performing the method of the third aspect to provide a hollow moulded fibre product, and then performing at least one additional process on at least one of the hollow moulded fibre products to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the internally coated product, the closable or closed product, the externally coated product, the decorated product, the dried product, or the evaluated product.

In some examples, there is provided a method of providing a content-containing receptacle, the method comprising providing a receptacle obtained by the method of the sixth aspect and providing the contents in the receptacle to provide the content-containing receptacle.

In some examples, the providing the contents in the receptacle comprises putting the contents into the receptacle. In contrast, in some examples, the providing the receptacle comprises providing the receptacle with the contents already present in the receptacle, thereby providing the contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the method further comprises: closing an opening of the receptacle after the providing contents in the receptacle, and/or applying a label or indicia to the receptacle.

In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle.

In some examples, the applying the label or indicia to the receptacle occurs after the providing the contents in the receptacle (that is, the label or indicia is applied to the content-containing receptacle). In other examples, the applying the label or indicia to the receptacle occurs before or during the providing the contents in the receptacle.

In some examples, the applying occurs before the closing. In some examples, the applying occurs after the closing. In some examples, the applying occurs during the closing.

In some examples, there is provided use of a receptacle obtained by the method of the sixth aspect to contain contents.

The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise.

The contents may, for example, be in the form of any of those discussed above.

According to a seventh aspect of the present invention there is provided a hollow moulded fibre product manufacturing system, comprising a transfer device comprising a vacuum contact surface, wherein the transfer device is configured to: (i) move the vacuum contact surface towards a product located at a first location when the product is at the first location, wherein the product is a partially formed hollow moulded fibre product or a hollow moulded fibre product, (ii) apply a vacuum to the vacuum contact surface to retain the product in contact with the vacuum contact surface, and (iii) move the vacuum contact surface relative to the first location while the vacuum is applied to the vacuum contact surface to retain the product in contact with the vacuum contact surface, such that the transfer device carries the product towards a second location. As mentioned, in examples, the products may be necked, and the hollow moulded fibre product manufacturing system may therefore be a necked hollow moulded fibre product manufacturing system.

The use of such a transfer device within the manufacturing system provides an efficient and effective way of manufacturing hollow moulded fibre products. In particular, the use of a transfer device provides a repeatable and precise way to move the products between locations without requiring human intervention. The vacuum contact surface can provide a controlled way to handle the products without damaging them.

Applying a vacuum to the vacuum contact surface causes the product to be drawn towards and held against/on the vacuum contact surface via suction.

The transfer device may be known as a first transfer device when the product being carried is a partially formed hollow moulded fibre product, in some examples. The transfer device may be known as a second transfer device when the product being carried is a hollow moulded fibre product, in some examples.

In certain examples, retaining the product in contact with the vacuum contact surface comprises causing the product to be held in contact with the vacuum contact surface.

In some examples, the transfer device is configured to carry the product from the first location to the second location.

In some examples, moving the vacuum contact surface relative to the first location comprises moving the vacuum contact surface away from the first location.

In a particular arrangement, the vacuum contact surface has a three-dimensional surface profile corresponding to a three-dimensional surface profile of a portion of an outer surface of the product. Such a configuration allows the vacuum contact surface to hold/carry the product while conforming to the outer surface of the product, thereby avoiding the use of gripping/grabbing mechanisms, which can damage the delicate structure of the products.

In certain examples, the vacuum contact surface is rigid (such that it does not change shape upon contact with the product).

In examples, the three-dimensional surface profile of the vacuum contact surface is concave and/or curved.

As will be apparent from the discussion below, in examples where the product is a partially formed hollow moulded fibre product, the vacuum contact surface may be known as a first vacuum contact surface having a first three-dimensional surface profile corresponding to a three-dimensional surface profile of an outer surface of the partially formed hollow moulded fibre product. In examples where the product is a hollow moulded fibre product, the vacuum contact surface may be known as a second vacuum contact surface having a second three-dimensional surface profile corresponding to a three-dimensional surface profile of an outer surface of the hollow moulded fibre product.

In a particular arrangement, the three-dimensional surface profile of the vacuum contact surface corresponds to the three-dimensional surface profile of only a main body portion of the product, the product having the main body portion and a neck portion. In some cases, the neck portion of the product is delicate, so holding the product by only the body portion ensures that the neck portion is not damaged.

In certain examples, the main body portion is wider than the neck portion.

In some examples, the three-dimensional surface profile of the vacuum contact surface corresponds to the three-dimensional surface profile of the main body portion and a shoulder portion of the product, the product comprising a shoulder portion between the main body portion and the neck portion.

In some examples, the vacuum contact surface is removeable from the transfer device and the transfer device comprises a holder configured to couple with the vacuum contact surface. This allows different sized/shaped vacuum contact surfaces to be coupled with, such as slotted into, the holder, thereby adapting the transfer device for different uses (such as for different sized/shaped products).

In one arrangement, the product is a partially formed hollow moulded fibre product, and the system further comprises: (i) at the first location, a first mould cavity configured to receive a fibre suspension for forming the partially formed hollow moulded fibre product therein, (ii) at the second location, a second mould cavity configured to receive the partially formed hollow moulded fibre product from the first mould cavity for further processing the partially formed hollow moulded fibre product in the second mould cavity to provide a hollow moulded fibre product, and the transfer device is configured to transfer the partially formed hollow moulded fibre product from the first mould cavity to the second mould cavity.

The transfer device therefore provides an effective way of transferring/moving products between the first and second mould cavities without requiring human intervention.

In an example, the first location comprises a first mould having the first mould cavity, and the second location comprises a second mould having the second mould cavity.

In some examples, transferring/moving the partially formed product to the second mould cavity comprises depositing the partially formed product directly into the second mould cavity. In other examples, transferring/moving the partially formed product to the second mould cavity comprises transferring/moving the partially formed product to a location in the vicinity of the second mould cavity, before one or more external forces causes the partially formed product to be deposited directly into the second mould cavity. For example, a positive pressure applied to the vacuum contact surface and/or a vacuum applies to the second mould cavity may cause the partially formed product to move into the second mould cavity.

In an example, and in any of the examples described herein, the further processing the partially formed hollow moulded fibre product comprises thermoforming the partially formed product by the application of heat and/or pressure.

In some arrangements, the system further comprises: (i) at the first location, a plurality of first mould cavities configured to receive a fibre suspension for forming respective partially formed hollow moulded fibre products therein, (ii) at the second location, a plurality of second mould cavities configured to receive the respective partially formed hollow moulded fibre products from the plurality of first mould cavities for further processing the respective partially formed hollow moulded fibre products in the plurality of second mould cavities to provide hollow moulded fibre products, wherein: (a) the transfer device comprises two or more vacuum contact surfaces, each vacuum contact surface being configured to contact a respective partially formed hollow moulded fibre product, and (b) the transfer device is configured to simultaneously transfer two or more partially formed hollow moulded fibre products from respective first mould cavities of the plurality of first mould cavities to respective second mould cavities of the plurality of second mould cavities.

Providing a transfer device that can simultaneously transfer two or more partially formed hollow moulded fibre products improves productivity and increases output of the manufacturing system by limiting the amount of transfer operations by the transfer device. The use of individual vacuum contact surfaces provides a tailored way of supporting and securing each partially formed product.

In some examples, the first location comprises a plurality of first moulds, each first mould having a first mould cavity and the second location comprises a plurality of second moulds, each second mould having a second mould cavity.

In some arrangements, the system further comprises a second transfer device configured to transfer a hollow moulded fibre product from the second mould cavity towards a further location.

The use of a second transfer device means that the first transfer device remains free to transfer partially formed products between the first and second mould cavities, and the use of two transfer devices means that each transfer device can operate in a more limited area of the manufacturing facility, simplifying the movement range and complexity of each transfer device.

The second transfer device may have the same components (possibly with different dimensions) as the first transfer device. For example, the second transfer device may also comprise one or more vacuum contact surfaces.

In some configurations, the second transfer device comprises a second vacuum contact surface configured to retain the hollow moulded fibre product in contact with the second vacuum contact surface while the hollow moulded fibre product is being carried from the second mould cavity to the further location. The vacuum contact surface has a first three-dimensional surface profile corresponding to a three-dimensional surface profile of an outer surface of the partially formed hollow moulded fibre product, the second vacuum contact surface has a second three-dimensional surface profile corresponding to a three-dimensional surface profile of an outer surface of the hollow moulded fibre product, and the first three-dimensional surface profile is different to the second three-dimensional surface profile.

The use of two transfer devices with different surface profiles provides a more tailored way of handling the products which can have different outer surface profiles as a result of being moulded in the first and second moulds.

In examples, “different” may mean a different shape or the same shape but with different dimensions. In a specific example, the partially formed hollow moulded fibre product (i.e., the product before thermoforming) has a first radius of curvature, the hollow moulded fibre product (i.e., the product after thermoforming) has a second radius of curvature, the first radius of curvature being greater than the second radius of curvature, the first three-dimensional surface profile has a radius of curvature corresponding to the first radius of curvature and the second three-dimensional surface profile has a radius of curvature corresponding to the second radius of curvature.

In some configurations, the product is a hollow moulded fibre product, and the system further comprises: at the first location, a second mould cavity configured to receive a partially formed hollow moulded fibre product for further processing the partially formed hollow moulded fibre product in the second mould cavity to provide a hollow moulded fibre product and the transfer device is configured to transfer the hollow moulded fibre product from the second mould cavity towards the second location. In some examples, the system further comprises, at a different location, a first mould cavity configured to receive a fibre suspension for forming the partially formed hollow moulded fibre product therein.

In some examples, the transfer device is a second transfer device, and the system comprises a first transfer device configured to transfer a partially formed hollow moulded fibre product from the first mould cavity to the second mould cavity.

In certain examples, the second location comprises a moving surface (such as a conveyor belt) or a further processing station, such as a coater or an evaluator, for performing a further process on the hollow moulded fibre product.

In examples, the transfer device is configured to: (i) stop the vacuum contact surface at a position in which the hollow moulded fibre product does not contact another surface at the second location, and (ii) one or more of: (a) remove or reduce the vacuum applied to the vacuum contact surface such that the hollow moulded fibre product is deposited at the second location, and (b) apply a positive pressure to the hollow moulded fibre product on the vacuum contact surface to urge the hollow moulded fibre product away from the vacuum contact surface, such that the hollow moulded fibre product is deposited at the second location.

Stopping at the position in which the product does not contact the other surface can mean that the product is less likely to be compressed between the surface at the second location and the vacuum contact surface. This can also mean that the control system that controls movement of the transfer device need not be as precise at positioning the product. As such, the product can be dropped onto or “blown” towards the surface.

Applying a positive pressure (via the vacuum contact surface) may comprise blowing air out of the vacuum contact surface. This air flow then causes the hollow moulded fibre product to move away from the vacuum contact surface.

In examples, the position is a position above the surface.

In some configurations, the system further comprises, at the second location, a moving surface, and the transfer device is configured to move the vacuum contact surface to a position in which the hollow moulded fibre product contacts the moving surface at the second location such that the movement of the moving surface causes the hollow moulded fibre product to move away from the vacuum contact surface.

The movement of the moving surface can therefore aid in decoupling the product from the vacuum contact surface. In one example, the moving surface is a conveyor belt.

In certain examples, the transfer device is further configured to one or more of: (i) remove or reduce the vacuum applied to the vacuum contact surface, and (ii) apply a positive pressure to the hollow moulded fibre product on the vacuum contact surface to urge the hollow moulded fibre product away from the vacuum contact surface. In some examples, this procedure is performed responsive to the system determining that the hollow moulded fibre product is still in contact with the vacuum contact surface after performing the procedure of stopping the vacuum contact surface at a position in which the hollow moulded fibre product does not contact another surface at the second location and removing or reducing the vacuum from the vacuum contact surface or applying a positive pressure.

In one configuration, the system comprises, at the first location, a mould cavity and the system is configured to apply a vacuum to the mould cavity to retain the product in contact with the mould cavity. The transfer device being configured to apply the vacuum to the vacuum contact surface to retain the product in contact with the vacuum contact surface comprises the system being configured to one of: (a) apply the vacuum to the vacuum contact surface and remove or reduce the vacuum applied to the mould cavity, (b) apply the vacuum to the vacuum contact surface and apply a positive pressure to the product within the mould cavity to urge the product towards the vacuum contact surface, and (c) apply a greater negative pressure to the vacuum contact surface than a negative pressure applied to the mould cavity to draw the product towards the vacuum contact surface.

Having a vacuum applied to both the vacuum contact surface and mould cavity provides a precise way of transferring the product from the mould cavity to the transfer device, while reducing the likelihood of the product being dropped.

In examples, the mould cavity is a first mould cavity. For example, the product may be a partially formed hollow moulded fibre product that is formed in the first mould cavity. In other examples, the mould cavity is a second mould cavity. For example, the product may be a hollow moulded fibre product that is formed in the second mould cavity.

In certain examples, the mould cavity is a first mould cavity, and wherein the second location comprises a second mould cavity, and the system is further configured to: (a) apply a vacuum to the second mould cavity, (b) move the vacuum contact surface towards the second mould cavity, and one of: (i) remove or reduce the vacuum applied to the vacuum contact surface, (ii) apply a positive pressure to the product on the vacuum contact surface to urge the product towards the second mould cavity, and (iii) apply a greater negative pressure to the second mould cavity than a negative pressure applied to the vacuum contact surface to draw the product towards the second mould cavity.

In some arrangements, the transfer device being configured to move the vacuum contact surface towards the product located at the first location when the product is at the first location, comprises the transfer device being configured to: (i) stop the vacuum contact surface at a position in which the vacuum contact surface does not contact an outer surface of the product when the product is at the first location, and (ii) apply the vacuum to the vacuum contact surface such that the product moves from the first location to being in contact with the vacuum contact surface via a position in which the product does not contact any surface. The product can therefore be “pulled” towards the vacuum contact surface and/or be “pushed” away from the first location. Not contacting any surface can mean that the product is airborne for a short period of time. Furthermore, stopping the vacuum contact surface in this position can mean that the product is less likely to be compressed between a surface at the first location and the vacuum contact surface. This can also mean that the control system that controls movement of the transfer device need not be as precise when collecting the product. Alternatively, the transfer device is configured to move the vacuum contact surface towards the product located at the first location when the product is at the first location such that the vacuum contact surface is in contact with an outer surface of the product when the product is at the first location.

In certain examples, the transfer device is configured to move the vacuum contact surface to a position in which the product is in contact with a second mould cavity at the second location. Alternatively, the system is configured to apply a vacuum to the second mould cavity such that the product moves from the vacuum contact surface to being in contact with the second mould cavity via a position in which the product does not contact any surface.

According to an eighth aspect of the present invention there is provided a receptacle manufacturing line comprising the hollow moulded fibre product manufacturing system of the seventh aspect, and apparatus for performing at least one additional process on at least one of the products to provide a receptacle.

The apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a bottle, jar or a type of vase. In a particular example, the receptacle is a bottle.

According to a ninth aspect of the present invention there is provided a method, comprising: (i) moving a vacuum contact surface of a transfer device towards a product when the product is at a first location, wherein the product is a partially formed hollow moulded fibre product or a hollow moulded fibre product, (ii) applying a vacuum to the vacuum contact surface to retain the product in contact with the vacuum contact surface, and (iii) moving the vacuum contact surface relative to the first location while the vacuum is applied to the vacuum contact surface to retain the product in contact with the vacuum contact surface, such that the transfer device carries the product towards a second location.

In some examples the method is a method of transferring a product from a first location to a second location (such that the transfer device carries the product to the second location).

In examples, the method comprises: (i) selecting the vacuum contact surface from plural differently-dimensioned available vacuum contact surfaces, and (ii) coupling the selected vacuum contact surface to a holder of the transfer device.

In some examples, the product is a partially formed hollow moulded fibre product, the first location comprises a first mould cavity configured to receive a fibre suspension for forming the partially formed hollow moulded fibre product therein, the second location comprises a second mould cavity configured to receive the partially formed hollow moulded fibre product from the first mould cavity for further processing the partially formed hollow moulded fibre product in the second mould cavity to provide a hollow moulded fibre product, and the method comprises moving the partially formed hollow moulded fibre product from the first mould cavity to the second mould cavity using the transfer device.

In some examples, the method comprises introducing a fibre suspension into the first mould cavity, urging the fibre suspension against an inner surface of the first mould cavity to form the partially formed hollow moulded fibre product, and opening the first mould cavity to expose an outer surface of the partially formed hollow moulded fibre product, wherein applying the vacuum to the vacuum contact surface to retain the partially formed hollow moulded fibre product in contact with the vacuum contact surface comprises applying the vacuum to the vacuum contact surface to retain the outer surface of the partially formed hollow moulded fibre product in contact with the vacuum contact surface.

In some examples, moving the partially formed hollow moulded fibre product from the first mould cavity to the second mould cavity using the transfer device comprises: moving the vacuum contact surface of the transfer device towards the product when the product is in the first mould cavity, applying the vacuum to the vacuum contact surface to retain the product in contact with the vacuum contact surface, and moving the vacuum contact surface relative to the first mould cavity while the vacuum is applied to the vacuum contact surface to retain the product in contact with the vacuum contact surface, such that the transfer device carries the product from the first mould cavity towards the second mould cavity.

In examples, the first location comprises a plurality of first mould cavities configured to receive a fibre suspension for forming respective partially formed hollow moulded fibre products therein, the second location comprises a plurality of second mould cavities configured to receive the respective partially formed hollow moulded fibre products from the plurality of first mould cavities for further processing the respective partially formed hollow moulded fibre products in the plurality of second mould cavities to provide hollow moulded fibre products, and the transfer device comprises two or more vacuum contact surfaces, each vacuum contact surface being configured to contact a respective partially formed hollow moulded fibre product, and the method comprises simultaneously transferring two or more partially formed hollow moulded fibre products from respective first mould cavities of the plurality of first mould cavities to respective second mould cavities of the plurality of second mould cavities using the transfer device.

In some examples, the first mould cavities are aligned along a first axis, the second mould cavities are aligned along a second axis, the two or more partially formed hollow moulded products are aligned along a third axis on the transfer device, and the simultaneously transferring two or more partially formed hollow moulded fibre products from respective first mould cavities of the plurality of first mould cavities to respective second mould cavities of the plurality of second mould cavities using the transfer device comprises: moving the two or more vacuum contact surfaces relative to the plurality of first and second mould cavities such that the third axis moves from a first position in which the third axis is coincident with the first axis, to a second position in which the third axis is coincident with the second axis.

In examples, the method further comprises: (i) moving a vacuum contact surface of a second transfer device towards the hollow moulded fibre product when the hollow moulded fibre product is in the second mould cavity, (ii) applying a vacuum to the vacuum contact surface of the second transfer device to retain the hollow moulded fibre product in contact with the vacuum contact surface of the second transfer device, and (iii) moving the vacuum contact surface of the second transfer device relative to the second mould cavity while the vacuum is applied to the vacuum contact surface of the second transfer device to retain the hollow moulded fibre product in contact with the vacuum contact surface of the second transfer device, such that the second transfer device carries the hollow moulded fibre product from the second mould cavity towards a further location.

In a particular example, the product is a hollow moulded fibre product, the first location comprises a second mould cavity configured to receive a partially formed hollow moulded fibre product for further processing the partially formed hollow moulded fibre product in the second mould cavity to provide a hollow moulded fibre product, and the method comprises moving the hollow moulded fibre product from the second mould cavity to the second location using the transfer device.

In some examples, the transfer device is a second transfer device.

In examples, the method comprises introducing a partially formed hollow moulded fibre product into the second mould cavity, urging the partially formed hollow moulded fibre product against an inner surface of the second mould cavity to form the hollow moulded fibre product, and opening the second mould cavity to expose an outer surface of the hollow moulded fibre product, wherein applying the vacuum to the vacuum contact surface to retain the hollow moulded fibre product in contact with the vacuum contact surface comprises applying the vacuum to the vacuum contact surface to retain the outer surface of the hollow moulded fibre product in contact with the vacuum contact surface.

In some examples, moving the hollow moulded fibre product from the second mould cavity towards the second location using the transfer device comprises: moving the vacuum contact surface of the transfer device towards the product when the product is in the second mould cavity, applying the vacuum to the vacuum contact surface to retain the product in contact with the vacuum contact surface, and moving the vacuum contact surface relative to the second mould cavity while the vacuum is applied to the vacuum contact surface to retain the product in contact with the vacuum contact surface, such that the transfer device carries the product from the second mould cavity towards the second location.

In examples, moving the hollow moulded fibre product from the second mould cavity towards the second location using the transfer device comprises: (i) stopping the vacuum contact surface at a position in which the hollow moulded fibre product does not contact another surface at the second location and one or more of: (a) removing or reducing the vacuum applied to the vacuum contact surface such that the hollow moulded fibre product is deposited at the second location, and (b) applying a positive pressure to the hollow moulded fibre product on the vacuum contact surface to urge the hollow moulded fibre product away from the vacuum contact surface, such that the hollow moulded fibre product is deposited at the second location.

In a particular example, the second location comprises a moving surface and wherein moving the hollow moulded fibre product from the second mould cavity towards the second location using the transfer device comprises: moving the vacuum contact surface to a position in which the hollow moulded fibre product contacts the moving surface at the second location such that the movement of the moving surface causes the hollow moulded fibre product to move away from the vacuum contact surface.

In some examples, the first location comprises a mould cavity, and the method further comprises: applying a vacuum to the mould cavity to retain the product in contact with the mould cavity, and applying the vacuum to the vacuum contact surface to retain the product in contact with the vacuum contact surface comprises one of: (i) applying the vacuum to the vacuum contact surface and removing or reducing the vacuum applied to the mould cavity, (ii) applying the vacuum to the vacuum contact surface and applying a positive pressure to the product to urge the product towards the vacuum contact surface, and (iii) applying a greater negative pressure to the vacuum contact surface than a negative pressure applied to the mould cavity to draw the product towards the vacuum contact surface.

In examples, the mould cavity is a first mould cavity. For example, the product may be a partially formed hollow moulded fibre product that is formed in the first mould cavity. In other examples, the mould cavity is a second mould cavity. For example, the product may be a hollow moulded fibre product that is formed in the second mould cavity.

In examples, the mould cavity is a first mould cavity, and the second location comprises a second mould cavity, the method further comprising: applying a vacuum to the second mould cavity, moving the vacuum contact surface towards the second mould cavity and one of: (a) removing or reducing the vacuum applied to the vacuum contact surface, (b) applying a positive pressure to the product on the vacuum contact surface to urge the product towards the second mould cavity, and (c) applying a greater negative pressure to the second mould cavity than a negative pressure applied to the vacuum contact surface to draw the product towards the second mould cavity.

In a particular example, moving the vacuum contact surface of the transfer device towards the product when the product is at the first location comprises moving the vacuum contact surface to a position in which the vacuum contact surface is in contact with an outer surface of the product when the product is at the first location.

In some examples, the moving the vacuum contact surface relative to the first location while the vacuum is applied to the vacuum contact surface to retain the product in contact with the vacuum contact surface, such that the transfer device carries the product towards the second location, comprises stopping the vacuum contact surface at a position in which the product does not contact the second mould cavity, and the method further comprises applying a vacuum to the second mould cavity such that the product moves from the vacuum contact surface to being in contact with the second mould cavity via a position in which the product does not contact any surface.

In some examples, moving the vacuum contact surface relative to the first location while the vacuum is applied to the vacuum contact surface to retain the product in contact with the vacuum contact surface, such that the transfer device carries the product towards the second location, comprises moving the vacuum contact surface to a position in which the product is in contact with the second mould cavity. In some cases, holding the product between the vacuum contact surface and the second mould cavity reduces the likelihood of dropping the product.

In a particular example, moving the vacuum contact surface of the transfer device towards the product when the product is at the first location comprises stopping the vacuum contact surface at a position in which the vacuum contact surface does not contact an outer surface of the product when the product is at the first location, and applying the vacuum to the vacuum contact surface to retain the product in contact with the vacuum contact surface comprises: applying the vacuum such that the product moves from the first location to being in contact with the vacuum contact surface via a position in which the product does not contact any surface.

According to a tenth aspect of the present invention there is provided a hollow-moulded-fibre-product-manufacturing-system controller configured to cause a hollow moulded fibre product manufacturing system to perform the method of the ninth aspect.

In examples, the hollow-moulded-fibre-product-manufacturing-system controller is or comprises a processor.

According to an eleventh aspect of the present invention there is provided a non-transitory storage medium storing machine-readable instructions that, when executed by a hollow-moulded-fibre-product-manufacturing-system controller, cause a hollow moulded fibre product manufacturing system to perform the method of the ninth aspect.

In some examples, there is provided a storage medium storing machine-readable instructions that, when executed by a hollow-moulded-fibre-product-manufacturing-system controller, cause a hollow moulded fibre product manufacturing system to perform the method of the ninth aspect.

According to a twelfth aspect of the present invention there is provided a method of manufacturing a receptacle, the method comprising performing the method of the ninth aspect, and then performing at least one additional process on the product to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the internally coated product, the closable or closed product, the externally coated product, the decorated product, the dried product, or the evaluated product.

In some examples, the receptacle is a bottle, a jar or a type of vase.

In some examples there is provided a method of providing a content-containing receptacle, the method comprising providing a receptacle obtained by the method of the twelfth aspect and providing the contents in the receptacle to provide the content-containing receptacle.

In some examples, the providing the contents in the receptacle comprises putting the contents into the receptacle. In contrast, in some examples, the providing the receptacle comprises providing the receptacle with the contents already present in the receptacle, thereby providing the contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the receptacle is a bottle, a jar or a type of vase.

In some examples, the method comprises: closing an opening of the receptacle after the providing contents in the receptacle, and/or applying a label or indicia to the receptacle.

In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle.

In some examples, the applying the label or indicia to the receptacle occurs after the providing the contents in the receptacle (that is, the label or indicia is applied to the content-containing receptacle). In other examples, the applying the label or indicia to the receptacle occurs before or during the providing the contents in the receptacle.

In some examples, the applying occurs before the closing. In some examples, the applying occurs after the closing. In some examples, the applying occurs during the closing.

In some examples, there is provided use of a receptacle obtained by the method of the twelfth aspect to contain contents.

The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise.

The contents may, for example, be in the form of any one of those discussed above.

In some examples, the receptacle is a bottle, a jar or a type of vase.

According to a thirteenth aspect of the present invention there is provided a hollow moulded fibre product manufacturing system, comprising: (a) a first mould cavity, (b) a second mould cavity, (c) a transfer device for transferring a partially formed hollow moulded fibre product from the first mould cavity to the second mould cavity for further processing the partially formed hollow moulded fibre product in the second mould cavity to provide a hollow moulded fibre product, the transfer device comprising a contact surface. The transfer device is configured to: (i) move the contact surface towards the partially formed hollow moulded fibre product when the partially formed hollow moulded fibre product is in the first mould cavity, to facilitate collection of the partially formed hollow moulded fibre product from the first mould cavity, (ii) move the contact surface away from the first mould cavity to facilitate movement of the partially formed hollow moulded fibre product away from the first mould cavity, and (d) an inspection system configured to inspect the partially formed hollow moulded fibre product to obtain a state of the partially formed hollow moulded fibre product after the transfer device has moved the contact surface of the transfer device away from the first mould cavity. The system is configured to perform an action based on the state of the partially formed hollow moulded fibre product.

As mentioned, in examples, the products may be necked, and the hollow moulded fibre product manufacturing system may therefore be a necked hollow moulded fibre product manufacturing system.

In an example, the inspection system is configured to inspect the partially formed hollow moulded fibre product to obtain a state of the partially formed hollow moulded fibre product after the transfer device has moved the partially formed hollow moulded fibre product away from the first mould cavity.

Providing the inspection system to inspect the partially formed product after being removed from the first mould cavity provides a more efficient system by taking appropriate action earlier in the manufacturing process. Furthermore, determining the state at this point in time may avoid damaging or disrupting the second mould cavity. For example, a product misaligned on the transfer device (and therefore potentially subsequently within the second mould cavity) may stop the second mould cavity from closing or operating as intended.

In certain examples, the contact surface is a vacuum contact surface. Any features described in relation to a vacuum contact surface may be applied to or present on the contact surface. The transfer device or the system is configured to apply a vacuum to the vacuum contact surface to retain the partially formed hollow moulded fibre product in contact with the vacuum contact surface.

In some examples, the inspection system determines the state of the partially formed hollow moulded fibre product (i.e., to obtain may mean to determine). In certain examples, the inspection system may receive the state of the partially formed hollow moulded fibre product from a remote location (such as a remote controller or remote server).

In certain examples, the system is configured to perform one or more actions based on the state of the partially formed hollow moulded fibre product.

The contact surface is configured to hold the partially formed hollow moulded fibre product against (and in contact with) the contact surface.

In some examples, the inspection system is configured to inspect the partially formed hollow moulded fibre product before the transfer device has deposited the partially formed hollow moulded fibre product in the second mould cavity.

In an example, the transfer device is configured to hold the partially formed hollow moulded fibre product while the inspection system inspects the partially formed hollow moulded fibre product to obtain the state.

Providing the inspection system to inspect the partially formed product as it is between the mould cavities provides a more efficient system since the partially formed product need not be set down to be inspected.

In some examples, the contact surface has a three-dimensional surface profile corresponding to a three-dimensional surface profile of a portion of an outer surface of the partially formed hollow moulded fibre product. This allows the contact surface to hold/carry the product while conforming to the outer surface of the product, thereby avoiding the use of gripping/grabbing mechanisms, which can damage the delicate structure of the products and may obscure parts of the product. By contacting a portion of the outer surface, at least the remaining (non-contacted) surface may be visible to be inspected by the inspection system.

In some examples, the three-dimensional surface profile of the contact surface is concave and/or curved.

In certain examples, the portion of the outer surface of the partially formed hollow moulded fibre product is less than about 60% of the surface area of the outer surface or less than about 50% or less than about 40% or less than about 25% or less than about 15%, such that at least 40% or at least 50% or at least 75% or at least 85% of the surface area of the partially formed hollow moulded fibre product is visible by the inspection system.

In a particular arrangement, the system further comprises: (i) a plurality of first mould cavities configured to receive a fibre suspension for forming respective partially formed hollow moulded fibre products therein, and (ii) a plurality of second mould cavities configured to receive the respective partially formed hollow moulded fibre products from the plurality of first mould cavities for further processing the respective partially formed hollow moulded fibre products in the plurality of second mould cavities to provide hollow moulded fibre products. The transfer device comprises two or more contact surfaces, each contact surface configured to contact a respective partially formed hollow moulded fibre product, such that the transfer device is configured to simultaneously transfer two or more partially formed hollow moulded fibre products from the plurality of first mould cavities to the plurality of second mould cavities. The inspection system is configured to inspect the two or more partially formed hollow moulded fibre products to obtain respective states of the partially formed hollow moulded fibre products after the transfer device has moved the two or more contact surfaces of the transfer device away from the plurality of first mould cavities, and the system is configured to perform one or more actions based on a state of one or more of the partially formed hollow moulded fibre products.

The transfer device can therefore carry and inspect a plurality of products at once, providing a more efficient manufacturing system

In some examples, the system is configured to perform one or more actions for one of the partially formed hollow moulded fibre products and one or more actions for another of the partially formed hollow moulded fibre products. In some examples, the system is configured to perform one or more actions for one of the partially formed hollow moulded fibre products and one or more different actions for another of the partially formed hollow moulded fibre products.

In examples, the further processing the partially formed hollow moulded fibre product comprises thermoforming the partially formed product by the application of heat and pressure.

In a particular example, the two or more contact surfaces are aligned along an axis on the transfer device.

Having the products aligned along an axis can make inspection easier, since they do not obstruct each other while being inspected.

In one configuration, the inspection system comprises an image capture device to capture an image of the partially formed hollow moulded fibre product, wherein the state of the partially formed hollow moulded fibre product is determined based on the image. The product may be on the transfer device as the image is captured.

An image capture device, such as a camera, is a low cost, non-intrusive and effective way to visually determine the state of the product.

The image may be transmitted to a remote server for image processing. The data from the image processing may be transferred back to the inspection system, which itself determines the state based on the data. The inspection system may comprise a controller. Alternatively, the remote server may itself determine the state and transfer the state back to the inspection system.

In a particular example, there is an image capture device for each partially formed hollow moulded fibre product being carried by the transfer device. For example, if the transfer device carries four partially formed hollow moulded fibre products, there may be four image capture devices. Alternatively, there may be one image capture device, the image capture device being configured to capture an image of the two or more partially formed products being carried by the transfer device.

In some arrangements, the transfer device is configured to stop the contact surface at a particular location, relative to the inspection system, and wherein the inspection system is configured to inspect the partially formed hollow moulded fibre product while the contact surface is stopped at the particular location.

Stopping in a stationary position may allow a more precise and accurate determination of the state of the product.

In this scenario, the contact surface is thus stationary at the particular location, relative to the inspection system. In other words, the contact surface is moveable relative to the inspection system (i.e., the inspection system is not collocated with the contact surface/transfer device).

In certain examples, the inspection system is configured to inspect the partially formed hollow moulded fibre product while the transfer device is moving the contact surface relative to the inspection system. Determining the state while moving can ensure the manufacturing process proceeds most efficiently.

In certain examples, the inspection system is in a fixed position relative to the contact surface such that the inspection system moves with the contact surface as the contact surface is moved by the transfer device.

Determining the state while moving can ensure the manufacturing process proceeds most efficiently. Furthermore, the fixed relative positioning may allow a more precise and accurate determination of the state of the product.

In this scenario, the inspection system is affixed to the transfer device. The inspection system is collocated with the contact surface.

In examples, the transfer device being configured to move the contact surface away from the first mould cavity to move the partially formed hollow moulded fibre product away from the first mould cavity comprises the transfer device being configured to move the contact surface away from the first mould cavity and the second mould cavity and towards the inspection system.

The inspection system may be on an opposite side of the first mould cavity to the second mould cavity. Such a positioning means that, should the partially formed product be damaged or require human inspection, the transfer device has already moved the partially formed product away from the first and second mould cavities. Furthermore, this means that the inspection system is arranged away from the moving parts associated with the first and second mould cavities.

In a particular example, the second mould cavity is located on one side of the first mould cavity and the inspection system is located on an opposite side of the first mould cavity.

In a particular example the state is: the partially formed hollow moulded fibre product is unsuitable for transfer to the second mould cavity.

In another example the state is: the partially formed hollow moulded fibre product is suitable for transfer to the second mould cavity.

In another example the state is: the partially formed hollow moulded fibre product is not present on the contact surface.

In another example the state is: the partially formed hollow moulded fibre product requires human inspection.

In another example the state is: the partially formed hollow moulded fibre product is misaligned on the contact surface.

In some examples, the state is any one of the above example states. In examples, the state changes over time. For example, an initial state may be that the partially formed hollow moulded fibre product requires human inspection, but after inspection, the state may be changed to any other of the above states, such as suitable (or not suitable) for transfer to the second mould cavity.

In some examples, being unsuitable for transfer to the second mould cavity may comprise the partially formed hollow moulded fibre product being damaged. For example, the partially formed product may be malformed, not fully formed, a wall of the partially formed product may be uneven, such as too thick or too thin, etc.

In a particular example, the transfer device is configured to perform the action based on the state of the partially formed hollow moulded fibre product.

In certain examples a further action may be taken by another element of the system based on the state.

In an example, the action comprises the transfer device being configured to: (i) move the contact surface back towards the first mould cavity to collect the partially formed hollow moulded fibre product from the first mould cavity.

In another example, the action comprises the transfer device being configured to: (ii) deposit the partially formed hollow moulded fibre product at a different location instead of in the second mould cavity.

In another example, the action comprises the transfer device being configured to: (iii) move the contact surface towards a different location to deposit the partially formed hollow moulded fibre product at the different location instead of in the second mould cavity.

In another example, the action comprises the transfer device being configured to: (iv) await human inspection before taking a further action.

In another example, the action comprises the transfer device being configured to: (v) move the contact surface towards a different location to await human inspection.

In another example, the action comprises the transfer device being configured to: (vi) move the contact surface towards the second mould cavity to deposit the partially formed hollow moulded fibre product in the second mould cavity.

In some examples, the action is any one of the above example actions.

In some examples, action (i) may occur when the partially formed hollow moulded fibre product is not present on the contact surface. In some examples, action (ii) may occur when the partially formed hollow moulded fibre product is unsuitable for transfer to the second mould cavity, or when the partially formed hollow moulded fibre product is misaligned on the contact surface. In some examples, action (ii) may occur without further movement. For example, the contact surface may be at the different location (i.e., stationary) when the inspection device determines the state, and the partially formed hollow moulded fibre product may be deposited there. In some examples, action (iii) may occur when the partially formed hollow moulded fibre product is unsuitable for transfer to the second mould cavity, or when the partially formed hollow moulded fibre product is misaligned on the contact surface. Action (iii) may correspond to option (ii), but the contact surface moves to that location before depositing the partially formed hollow moulded fibre product. In some examples, action (iv) may occur if the inspection system is unable to accurately determine the state. For example, the state may be: undetermined. After the inspection, the transfer device may receive a further instruction to perform a further action. For example, a user may provide an input to the system which causes the transfer device to perform the further action, such as continue to move towards the second mould cavity to deposit the partially formed hollow moulded fibre product in the second mould cavity.

In examples, the transfer device being configured to deposit the partially formed hollow moulded fibre product comprises the transfer device being configured to apply a positive pressure to the partially formed hollow moulded fibre product on the contact surface to urge the partially formed hollow moulded fibre product away from the contact surface.

In another example, the action comprises the system being configured to cause output of a notification. In another example, the action comprises the system being configured to cause a cleaning assembly to perform a cleaning operation on the first mould cavity. In examples, the action comprises the system being configured to cause either or both of these actions to occur.

In some examples, the system comprises the cleaning assembly.

The notification may be an audio, visual or haptic notification, for example. The notification may alert a human operator to inspect at least one of the transfer device, the first mould cavity and/or the partially formed hollow moulded fibre product.

In one example, after the transfer device has deposited one or more partially formed hollow moulded fibre products in one or more second mould cavities, and before the transfer device collects one or more further partially formed hollow moulded fibre products from one or more first mould cavities, the inspection system can inspect the transfer device (i.e., the one or more contact surfaces) to, for example, verify/determine that the transfer device is in fact empty (i.e., to check that the products have been deposited and are not “stuck” on the contact surfaces). This will prevent collisions of partially formed hollow moulded fibre product that should not be on the transfer device when it is picking up more products. As such, the inspection system is configured to inspect the contact surface of the transfer device after the transfer device has transferred the partially formed hollow moulded fibre product to the second mould cavity. The inspection system may determine that the contact surface (or contact surfaces, if there are more than one) are vacant, and cause/allow the transfer device to collect one or more further partially formed hollow moulded fibre products from the one or more first mould cavities. If any of the partially formed hollow moulded fibre products are present on the transfer device, the partially formed hollow moulded fibre product(s) can be removed, either automatically or manually. For example, the transfer device can perform an action, where the action is one of the previously described actions. Alternatively or additionally, the inspection system may check to determine whether the contact surface (or contact surfaces, if there are more than one) are damaged.

According to a fourteenth aspect of the present invention there is provided a receptacle manufacturing line comprising the hollow moulded fibre product manufacturing system of the thirteenth aspect, and apparatus for performing at least one additional process on the hollow moulded fibre product formed in the second mould cavity to provide a receptacle.

The apparatus may comprise an interior coater and the at least one additional process may comprise the interior coater coating at least a portion of an interior of the product to produce an internally coated product. The apparatus may comprise a closure-part applicator and the at least one additional process may comprise the closure-part applicator applying a closure part to the product or the internally coated product to produce a closable or closed product. The apparatus may comprise an exterior coater and the at least one additional process may comprise the exterior coater coating at least a portion of an exterior of the product or the internally coated product or the closable or closed product to produce an externally coated product. The apparatus may comprise a decorator and the at least one additional process may comprise the decorator decorating the product or the internally coated product or the closable or closed product or the externally coated product to produce a decorated product. The apparatus may comprise a dryer and the at least one additional process may comprise the dryer drying the product or the internally coated product or the closable or closed product or the externally coated product or the decorated product to produce a dried product. The apparatus may comprise an evaluator and the at least one additional process may comprise the evaluator evaluating the product, the internally coated product, the closable or closed product, the externally coated product, the decorated product, or the dried product to produce an evaluated product. In some examples, the receptacle is the product, the internally coated product, the closable or closed product, the externally coated product, the decorated product, the dried product, or the evaluated product.

In some examples, the receptacle is a bottle, jar or a type of vase. In some examples, the receptacle is a bottle.

According to a fifteenth aspect of the present invention there is provided a method, comprising: (i) providing a transfer device for transferring a partially formed hollow moulded fibre product from a first mould cavity to a second mould cavity for further processing the partially formed hollow moulded fibre product in the second mould cavity to provide a hollow moulded fibre product, (ii) moving a contact surface of the transfer device towards the partially formed hollow moulded fibre product when the partially formed hollow moulded fibre product is in the first mould cavity, to facilitate collection of the partially formed hollow moulded fibre product from the first mould cavity, (iii) moving the contact surface of the transfer device away from the first mould cavity to facilitate movement of the partially formed hollow moulded fibre product away from the first mould cavity, (iv) after the moving the contact surface of the transfer device away from the first mould cavity, obtaining, by an inspection system, a state of the partially formed hollow moulded fibre product, (v) performing an action based on the state of the partially formed hollow moulded fibre product.

In some examples, the method comprises performing one or more actions based on the state. The action may be performed by the system itself, and/or the transfer device.

In examples, performing the action based on the state of the partially formed hollow moulded fibre product comprises: performing the action by the transfer device.

In one example the method comprises maintaining the partially formed hollow moulded fibre product in contact with the contact surface such that at least 40% of the surface area of the partially formed hollow moulded fibre product is visible by the inspection system when the inspection system obtains the state.

This allows the contact surface to hold/carry the product while at least the remaining (non-contacted) surface may be visible to be inspected by the inspection system.

In a particular example, the method comprises maintaining the partially formed hollow moulded fibre product in contact with the contact surface such that at least 50% or at least 60% or at least 75% or at least 85% of the surface area of the partially formed hollow moulded fibre product is visible by the inspection system.

In examples the method comprises: (i) simultaneously transferring two or more partially formed hollow moulded fibre products from a plurality of first mould cavities to respective second mould cavities of a plurality of second mould cavities using the transfer device, (ii) presenting, by the transfer device, the two or more partially formed hollow moulded fibre products to the inspection system such that the inspection system is able to obtain respective states of the partially formed hollow moulded fibre products, and (iii) performing one or more actions based on a state of one or more of the partially formed hollow moulded fibre products.

In some examples, the method comprises stopping the contact surface at a particular location, relative to the inspection system, and obtaining, by the inspection system, the state of the partially formed hollow moulded fibre product while the contact surface is stopped at the particular location.

In some examples, moving the contact surface of the transfer device away from the first mould cavity comprises moving the contact surface away from the first mould cavity and the second mould cavity and towards the inspection system.

In some examples, the state is one of: (i) the partially formed hollow moulded fibre product is unsuitable for transfer to the second mould cavity, (ii) the partially formed hollow moulded fibre product is suitable for transfer to the second mould cavity, (iii) the partially formed hollow moulded fibre product is not present on the contact surface, (iv) the partially formed hollow moulded fibre product requires human inspection, and (v) the partially formed hollow moulded fibre product is misaligned on the contact surface.

In some examples, the action comprises one of: (i) moving, by the transfer device, the contact surface back towards the first mould cavity to collect the partially formed hollow moulded fibre product from the first mould cavity, (ii) depositing, by the transfer device, the partially formed hollow moulded fibre product at a different location instead of in the second mould cavity, (iii) moving, by the transfer device, the contact surface towards a different location to deposit the partially formed hollow moulded fibre product at the different location instead of in the second mould cavity, (iv) awaiting, by the transfer device, human inspection before taking a further action, (v) moving, by the transfer device, the contact surface towards a different location to await human inspection, (vi) moving, by the transfer device, the contact surface towards the second mould cavity to deposit the partially formed hollow moulded fibre product in the second mould cavity.

In an example, depositing, by the transfer device, the partially formed hollow moulded fibre product comprises applying a positive pressure to the partially formed hollow moulded fibre product on the contact surface to urge the partially formed hollow moulded fibre product away from the contact surface.

The use of a positive pressure (such as a blast of air) provides a delicate and controllable method of depositing the partially formed product. Furthermore, applying a positive pressure can control how far and/or the direction in which the partially formed product is urged away from the contact surface.

In another example, the action comprises one or more of: causing output of a notification and causing a cleaning operation on the first mould cavity to be performed.

In some examples, the method comprises: sending, by the inspection system to a remote server, data indicative of the partially formed hollow moulded fibre product, the data being obtained by the inspection system, and receiving, by the inspection system from the remote server, the state of the partially formed hollow moulded fibre product, the state being determined based on the data. The data may be raw data obtained by the inspection system, or may be (at least initially) processed by the inspection system before being sent to the remote server. Processing of the data may also be performed by the remote server.

Thus, in some examples, a remote server is used to determine the state, which may be particularly useful in cases where local processing power is more limited.

According to a sixteenth aspect of the present invention there is provided a hollow-moulded-fibre-product-manufacturing-system controller configured to cause a hollow moulded fibre product manufacturing system to perform the method of the fifteenth aspect.

In examples, the hollow-moulded-fibre-product-manufacturing-system controller is or comprises a processor.

According to a seventeenth aspect of the present invention there is provided a non-transitory storage medium storing machine-readable instructions that, when executed by a hollow-moulded-fibre-product-manufacturing-system controller, cause a hollow moulded fibre product manufacturing system to perform the method of the fifteenth aspect.

In some examples, there is provided a storage medium storing machine-readable instructions that, when executed by a hollow-moulded-fibre-product-manufacturing-system controller, cause a hollow moulded fibre product manufacturing system to perform the method of any one of claims 13 to 22.

According to an eighteenth aspect of the present invention there is provided a method of manufacturing a receptacle, the method comprising performing the method of the fifteenth aspect and forming the hollow moulded fibre product in the second mould cavity, and then performing at least one additional process on the hollow moulded fibre product to provide the receptacle.

The at least one additional process may comprise coating at least a portion of an interior of the product to produce an internally coated product. The at least one additional process may comprise applying a closure part to the product or the internally coated product to produce a closable or closed product. The at least one additional process may comprise coating at least a portion of an exterior of the product or the internally coated product or the closable or closed product to produce an externally coated product. The at least one additional process may comprise decorating the product or the internally coated product or the closable or closed product or the externally coated product to produce a decorated product. The at least one additional process may comprise drying the product or the internally coated product or the closable or closed product or the externally coated product or the decorated product to produce a dried product. The at least one additional process may comprise evaluating the product, the internally coated product, the closable or closed product, the externally coated product, the decorated product, or the dried product to produce an evaluated product. In some examples, the receptacle is the internally coated product, the closable or closed product, the externally coated product, the decorated product, the dried product, or the evaluated product.

In some examples, the receptacle is a bottle, jar or a type of vase. In some examples, the receptacle is a bottle.

In some examples, there is provided a method of providing a content-containing receptacle, the method comprising providing a receptacle obtained by the method of the eighteenth aspect and providing the contents in the receptacle to provide the content-containing receptacle.

In some examples, the providing the contents in the receptacle comprises putting the contents into the receptacle. In contrast, in some examples, the providing the receptacle comprises providing the receptacle with the contents already present in the receptacle, thereby providing the contents in the receptacle.

The contents may be in the form of, for example, a liquid, a powder, other flowable materials, one or more solid objects, or a combination thereof. For example, the contents may be a foodstuff such as a condiment, a beverage such as an alcoholic beverage, a household care product such as a detergent or other cleaning product, a personal care product such as a hair care product or a personal cleansing product or a healthcare product or a pharmaceutical product or a cosmetics product, a fragrance product such as a perfume, a vehicle product such as motor oil, or an industrial product. Other suitable contents will be apparent to the skilled reader in view of the content of this application and their common general knowledge.

In some examples, the receptacle is a bottle, a jar or a type of vase. In some examples, the receptacle is a bottle.

In some examples, the method further comprises: closing an opening of the receptacle after the providing contents in the receptacle, and/or applying a label or indicia to the receptacle.

In some examples, the closing comprises applying a closure (such as a lid or a cap or a heat seal) to the receptacle to close the opening. In some examples, the closing comprises applying a heat seal to the receptacle and (e.g., thereafter) applying a lid or a cap to the receptacle.

In some examples, the applying the label or indicia to the receptacle occurs after the providing the contents in the receptacle (that is, the label or indicia is applied to the content-containing receptacle). In other examples, the applying the label or indicia to the receptacle occurs before or during the providing the contents in the receptacle.

In some examples, the applying occurs before the closing. In some examples, the applying occurs after the closing. In some examples, the applying occurs during the closing.

In some examples, there is provided use of a receptacle obtained by the method of the eighteenth aspect to contain contents.

The use could be, for example, by a person (such as a natural person or a company) who puts the contents into the receptacle, or by a person who transports the contents, or by a person who wishes to dispose of (e.g., to a consumer or end user), offer to dispose of (e.g., to a consumer or end user), import, or keep the contents whether for disposal or otherwise.

The contents may, for example, be in the form of any of those discussed above.

In some examples, the receptacle is a bottle, a jar or a type of vase. In some examples, the receptacle is a bottle.

It will be appreciated that optional features of aspects of the present invention may be equally applied to other aspects of the present invention, where appropriate.

### BRIEF DESCRIPTION OF THE DRAWINGS

Embodiments of the invention will now be described, by way of example only, with reference to the accompanying drawings, in which:

FIG. 1 is a schematic view of an example receptacle manufacturing line for performing a method of manufacturing receptacles from paper pulp;

FIG. 2 is a perspective schematic view of an example system;

FIG. 3 shows cross-sections of example moulds;

FIG. 4A shows a cross-section of an example mould before a fibre suspension is introduced into the mould cavity;

FIG. 4B shows a cross-section of the example mould after a fibre suspension has been applied to the inner wall of the cavity;

FIG. 4C shows a cross-section of the example mould after the fibre suspension has been urged against the inner wall of the mould cavity;

FIG. 5 is a perspective view of an example transfer device;

FIGS. 6A-6G are schematic top down views of the example system of FIG. 2 at various points in time;

FIG. 7A is a schematic side view of a transfer device before depositing a receptacle onto a moving surface, according to an example;

FIG. 7B is a schematic side view of the transfer device of FIG. 7A after depositing the receptacle onto the moving surface;

FIG. 8 is a schematic top down view of another example system in which an inspection system is coupled to a transfer device;

FIG. 9A is a perspective view of an example transfer device comprising a plurality of vacuum contact surfaces;

FIG. 9B is a perspective view of the example transfer device of FIG. 9A after the plurality of vacuum contact surfaces have been removed from the transfer device;

FIG. 10A is a perspective view of another example transfer device comprising a plurality of vacuum contact surfaces;

FIG. 10B is a perspective view of the example transfer device of FIG. 10A with a plurality of receptacles being held against the plurality of vacuum contact surfaces;

FIG. 11 is a flow diagram of a first example method;

FIG. 12 is a flow diagram of a second example method;

FIG. 13 is a flow diagram of a third example method;

FIG. 14 shows a computer-readable storage medium according to an example;

FIG. 15 shows a schematic cross-sectional view of a receptacle containing contents, according to an example; and

FIG. 16 shows a method of providing a content-containing receptacle.

### DETAILED DESCRIPTION

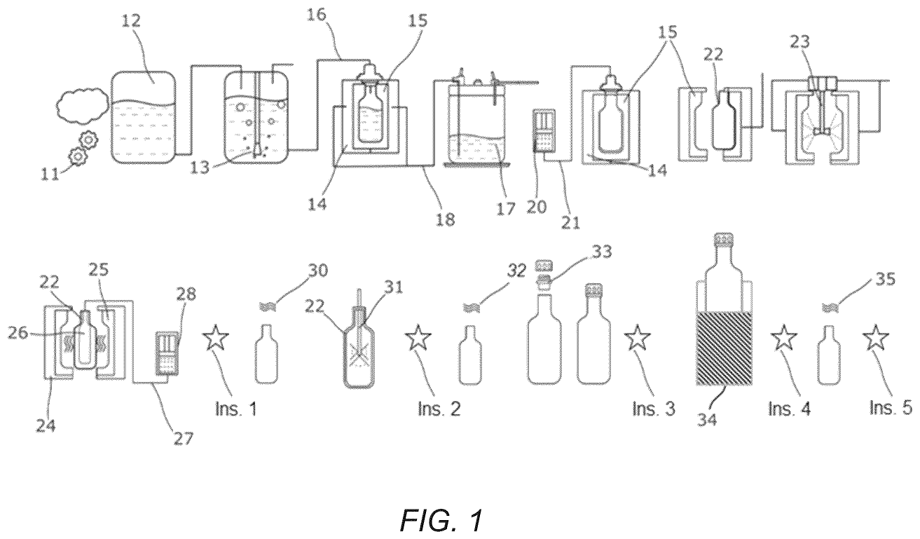

FIG. 1 shows a receptacle manufacturing line for performing a method of manufacturing receptacles, in this case necked receptacles, and more specifically in this case in the form of bottles, from paper pulp (i.e., which can form the basis of an example fibre suspension). By “necked receptacle” it is meant that the receptacle has an internal narrowing, or “neck”, between a main body portion, in which most of or all the contents of the receptacle are stored in use, and an opening through which the contents can enter or leave the receptacle in use. The internal width of the receptacle at the neck may be the same as or different to the internal width of the opening. However, the internal width of the neck is smaller than that of the main body portion, so that a shoulder is defined by and between the neck and the main body portion. This shoulder complicates manufacture of the receptacle, since it interferes with subsequent removal (and, in some cases, insertion) of whatever mould tool is inserted into the receptacle to form the internal shape of the receptacle. Examples of necked receptacles are bottles, jars, and certain types of vases. The process is merely exemplary and is provided to give context to examples of the present invention. It will be appreciated that, in other examples, the receptacle manufacturing line could be for making non-necked receptacles (i.e., receptacles without such a neck), such as bowls or trays.

Broadly speaking, the exemplary process comprises providing a fibre suspension, introducing the fibre suspension into a mould cavity of a porous first mould and expelling a liquid (such as water) from the fibre suspension to produce a partially formed hollow moulded fibre product (which may be called a wet precursor or embryo) in the mould cavity, further moulding the partially formed hollow moulded fibre product to produce a hollow further-moulded fibre product (also known as a hollow moulded fibre product), drying and then internally-coating the hollow further-moulded fibre product to produce an internally coated product, drying the internally coated product to produce a dried product, applying a closure part to the dried product to produce a closable or closed product, externally-coating and/or decorating the closable or closed product to produce an externally coated and/or decorated product, and then drying the externally coated or decorated product to produce another dried product. As will be apparent at least from the following description, modifications may be made to the exemplary process to provide variants thereof in which other examples of the present invention may be embodied. For example, in some cases, either the internal coating or the external coating and/or decorating may be omitted. Moreover, in the present case and as indicated by the stars labelled Ins. 1 to Ins. 5 in FIG. 1, the process comprises inspecting or evaluating the hollow further-moulded fibre product, the internally coated product, the closable or closed product, the externally coated or decorated product, and the dried product to produce respective evaluated products. In some examples, the receptacle is the partially formed hollow moulded fibre product, the hollow further-moulded fibre product, the internally coated product, the closable or closed product, the externally coated or decorated product, one of the dried products, or one of the respective evaluated products.

In this example, providing the fibre suspension comprises preparing the fibre suspension from ingredients thereof. More specifically, the preparing comprises providing pulp fibres, such as paper pulp fibres, and mixing the pulp fibres with a liquid to provide hydrated pulp fibres. In this example, the pulp fibres are provided in sheet form from a supplier and the liquid comprises water and one or more additives. In this example, the liquid is mixed with the pulp fibres to provide hydrated pulp fibres having a solid fibres content of 1 wt % to 5 wt % (by dry mass of fibres). In examples, the one or more additives includes a sizing agent, such as alkylketene dimer (AKD). The hydrated pulp fibres typically comprise AKD in an amount of 0.4 wt % with respect to the total dry mass of the solid fibres in the hydrated pulp fibres. In some examples, one or more additives are present in the liquid at the point of mixing the pulp fibres with the liquid. In some examples, one or more additives are included in the hydrated pulp fibres after mixing the pulp fibres with the liquid (for example, the pulp fibres are hydrated for a period of time, such as from 2 to 16 hours, and then one or more additives are supplied to the hydrated pulp fibres). The hydrated pulp fibres are passed between plates of a valley beater 11 or refiner that are in motion relative to each other. This fibrillates some, or all, of the fibres, meaning that cell walls of those fibres are caused to become partially delaminated so that wetted surfaces of those fibres comprise protruding hairs or fibrillations. These fibrillations will help to increase a strength of bonds between the fibres in the dried end product. In other examples, the valley beater 11 or refiner may be omitted.

The resultant processed pulp is stored in a vat 12 in a relatively concentrated form (for example, a solid fibres content of 1 wt % to 5 wt %) to reduce a required storage space. At an appropriate time, the processed pulp is transferred to a mixing station 13 at which the processed pulp is diluted in further water and, optionally, mixed with one or more additives (as well as, or in place of, the one or more additives provided with the hydrated pulp fibres) to provide the fibre suspension ready for moulding. In this example, the solid fibres account for 0.7 wt % of the resultant fibre suspension (by dry weight of fibres), but in other examples the proportion of solid fibres in the fibre suspension may be different, such as another value in the range of 0.5 wt % to 5 wt %, or 0.1 wt % to 1 wt %, of the fibre suspension (by dry weight of fibres). In some examples, the one or more additives mixed with the processed pulp and water includes a dewatering agent, such as modified and/or unmodified polyethylene imine (PEI), for example modified PEI sold under the trade name Polymin® SK. In some examples, the one or more additives are mixed with the water, and the water and one or more additives subsequently mixed with the processed pulp; in other examples, the processed pulp and water are mixed, and the one or more additives subsequently mixed with the processed pulp and water. The fibre suspension typically comprises Polymin® SK in an amount of 0.3 wt % with respect to the total dry mass of the solid fibres. Mixing of the fibre suspension at the mixing station 13 helps to homogenise the fibre suspension. In other examples, the processed pulp or the fibre suspension may be provided in other ways, such as being supplied ready-made.

Downstream of the vat 12 and the mixing station 13 is a first moulding station that comprises a porous first mould 15. In this example, the porous first mould 15 comprises two half-moulds 14 that are movable towards and away from each other, in this case using a hydraulic ram. In this example, each of the half-moulds is a monolithic or unitary tool formed by additive manufacturing (for example, 3D-printing) that defines a mould profile, and, when the half-moulds are brought into contact with each other, their respective mould profiles cooperate to define the mould cavity in which the partially formed hollow moulded fibre product is to be formed. Each half-mould itself defines a smaller moulding cavity and, when brought into cooperation with a second half-mould, the smaller moulding cavities combine to provide the overall mould cavity. The two half-moulds may themselves be considered “splits” or “moulds” and the overall porous first mould 15 may be considered a “split-mould” or, again, a “mould”. In other examples, the porous first mould 15 may comprise more than two splits, such as three, four or six splits, that cooperate to define the moulding cavity.

In FIG. 1, the fibre suspension (also known as slurry) is top-filled into the porous first mould 15, in contrast to moulding processes that dip a mould in slurry. The fibre suspension is drawn under vacuum via a line 16 and into the porous first mould 15, with excess suspending liquid being drawn through the porous first mould 15 under vacuum via a line 18 into a tank 17. Shot mass may be controlled by measuring (for example, weighing) the amount of liquid drawn into the tank 17. A weight scale platform supporting the tank 17 is visible in FIG. 1. Once a required amount (for example, a predetermined volume, such as 10 litres, or a predetermined mass, such as 10 kilograms) of liquid has been collected in the tank 17, suction of the suspending liquid through the porous first mould 15 is stopped and the first mould 15 is opened to ambient air. In this example, the suspending liquid drawn with the fibre suspension in line 16 is water, or predominantly water (as additives may also be present). The liquid drawn under vacuum via the line 18 and into the tank 17 is substantially free of fibres, since these are left behind against the walls of the porous first mould 15 to form the partially formed hollow moulded fibre product.

In one example, in order to remove further suspending liquid (for example, water) from the partially formed hollow moulded fibre product, and form or consolidate the three-dimensional shape of the product, high pressure fluid (such as compressed air) is introduced into the first mould 15 to compress the fibre suspension against the cavity wall of the first mould 15. This process strengthens the product so that it can be handled, and displaces water from in between the fibres, thereby increasing the efficiency of a subsequent drying process. The fluid is regulated using a hydraulic pump 20. The pump 20 has a cylinder that displaces the fluid in a line 21 into the first mould 15. In an alternative example, an impermeable inflation element in the form of a collapsible bladder is inserted into the first mould 15 and expanded, by introduction of a fluid into the bladder from the line 21, to act as an internal high-pressure core structure for the first mould 15. In such an alternative, the fluid within the line 21 is preferably non-compressible, such as water or oil, although in other examples it could be a compressible fluid, such as air. Water has the advantage over other non-compressible liquids that any leaking or bursting of the bladder will not introduce a new substance to the system (since the suspending liquid is already water, or predominantly water).

Demoulding occurs when the first mould 15 opens for removal of the self-supporting partially formed hollow moulded fibre product 22. Mould cleaning 23 is preferably performed subsequently, to remove any remaining small fibres and/or other debris and maintain a porosity of the porous first mould 15. In this example, a radially firing high-pressure jet is inserted into the mould cavity while the first mould 15 is open. This dislodges debris from the wall of the mould cavity. Alternatively, or in addition, water from the tank 17 is pressurised through the back of the porous first mould 15 to dislodge entrapped fibres and/or other debris. Water is drained for recycling back to an upstream part of the system. It is noteworthy that cleaning is important for conditioning the first mould 15 for re-use. The first mould 15 may appear visibly clean after removal of the receptacle, but its performance could be compromised without cleaning.

According to FIG. 1, the partially formed hollow moulded fibre product 22 is subsequently transported to a second moulding station where, in a, for example, aluminium, mould 25, pressure and heat are applied for thermoforming a desired neck and surface finish, optionally including embossed and/or debossed surface features. After two halves of the mould 25 have closed around the product 22, a pressuriser is engaged. For example, a bladder 26 (for example, a thermoforming bladder 26) is inserted into the product 22. The bladder 26 is inflated with a pressurised fluid supplied via a line 27 by a pump 28. The pressurised fluid is preferably a non-compressible fluid such as water or oil, although in other examples it could be a compressible fluid such as air. In other examples, during supply, the pressurised fluid is heated with, for example, a heater or, alternatively, is cooled with, for example, a heat exchanger. An external mould block 24 of the mould 25, and/or the mould 25 itself, is also, or alternatively, heated in some examples. After thermoforming, a state of the product 22, which may now be considered a hollow further-moulded fibre product (or a hollow moulded fibre product), is considerably more rigid, with more compressed side walls, as compared with the state of the product 22 at demoulding from the first mould 15.

A drying stage 30 (for example, a microwave drying process or other drying process) is performed on the product 22 downstream of the thermoforming, as shown, to provide a dried product. In one example, the drying stage 30 is performed before thermoforming to provide a dried product. However, moulding in the mould 25 requires some water content to assist with bonding during the compression process. The drying may be performed using a dryer, such as a machine that acts to cause drying of the product or simply a shelf or other support on which the product 22 rests while drying.

The product 22 is then subjected to an internal-coating stage during which, in this example, an interior coater in the form of a spray lance 31 is inserted into the product 22 and applies one or more surface coatings to internal walls of the product 22 to produce an internally coated product. In another example, the product 22 is instead filled with and subsequently drained of a liquid that coats the internal walls of the product 22. In practice, such coatings provide a protective layer to prevent egress of contents into the bottle wall, which may permeate and/or weaken it. Coatings will be selected dependent on the intended contents of finished receptacle, for example, a beverage, foodstuff, detergent, lubricant, pharmaceutical product, etc. In this example, the internally coated product 22 is then subjected to a curing or drying process 32, which can be configured or optimised dependent on the internal coating, for example, drying for twenty-four hours at ambient conditions or by a flash drying method. The drying again may be performed using a dryer, such as a machine that acts to cause drying of the product or simply a shelf or other support on which the product 22 rests while drying. Following the drying, the coated product 22 is considered another dried product.

A closure or mouth forming process is then performed on the product 22 by a closure-part applicator to produce a closable or closed product. For example, as shown in FIG. 1, a neck fitment 33 is affixed to the dried product. This results in the product being closable subsequently by positioning of a cap, lid or other closure relative to the neck fitment. An exterior coating and/or decoration is then applied to the product 22 by an exterior coater and/or a decorator, respectively, as shown in the further stage 34, to produce an externally coated and/or decorated product. In one example, the product 22 is dipped into a liquid to coat its outer surface, as shown in FIG. 1. In another example, the outer surface receives the external coating in a different manner. The coating and/or decoration may cover all or only part of an external surface of the product. The product 22 is then allowed to dry in warm air to produce another dried product. In other examples, the drying may be performed using a dryer such as one of those discussed above.

The product 22 may therefore be fully formed, considered the end “receptacle”, and ready to accept contents therein. In other examples, the receptacle may be fully formed without the neck fitment 35 being affixed and/or without the interior coating being applied and/or without the exterior coating being applied and/or without the decoration being applied and/or immediately after one of the drying processes or one of the inspecting and/or evaluating processes. For example, in some cases, the product is provided with the closure part by moulding the closure part during moulding of the product at the first moulding station and/or the second moulding station. In one example, the receptacle may be fully formed after being removed from mould 25.

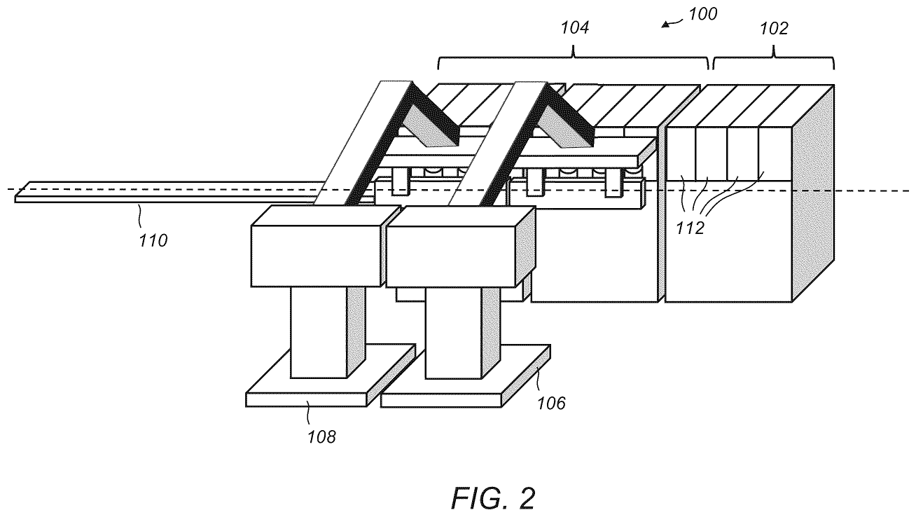

FIG. 2 depicts a schematic of an example hollow moulded fibre product manufacturing system 100. In certain examples, the system 100 may comprise any or all of the manufacturing stages depicted in FIG. 1. For brevity, the terms: (i) partially formed receptacle(s) and (ii) receptacle(s) will be used herein. It will be understood that any reference to a “partially formed receptacle” may be replaced by a “partially formed hollow moulded fibre product” and any reference to a “receptacle” or “formed receptacle” may be replaced by a “hollow moulded fibre product” or a “formed hollow moulded fibre product”. The term “receptacle” will be used to refer to any product formed in the second mould 25, as well as any downstream modifications made to that product (such as adding a lid, coating etc.). In some cases, the partially formed receptacles/products and formed receptacles/products are necked.

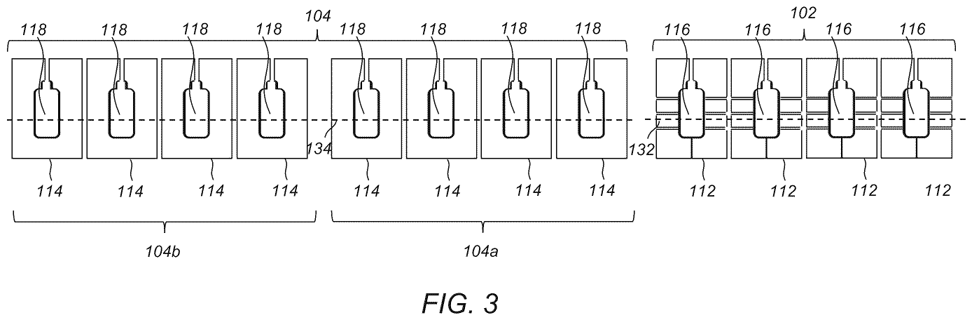

As shown in FIG. 2, the system 100 comprises a first moulding station 102 comprising a plurality of first moulds 112, each first mould 112 comprising a first mould cavity to receive a fibre suspension therein. Each first mould and first mould cavity can produce/form a partially formed receptacle. The first moulding station 102 may also be referred to as a first location, in some examples. The system 100 further comprises a second moulding station 104 comprising a plurality of second moulds (hidden from view), each second mould comprising a second mould cavity to receive a partially formed receptacle therein. Each second mould and second mould cavity can produce a “formed” receptacle. The second moulding station 104 may also be referred to as a second location, in some examples. As discussed with reference to FIG. 1, additional processes may be performed on the receptacle after removal from the second mould cavity. FIG. 3 shows the first moulds 112, the first mould cavities 116, the second moulds 114 and the second mould cavities 118 in isolation.

The system 100 of FIG. 2 further comprises a first transfer device 106 that transfers one or more partially formed receptacles from the plurality of first mould cavities 116 to the plurality of second mould cavities 118. In this example, the first transfer device 106 is a robotic arm that is moveable within the system 100. The first transfer device 106 is configured to collect one or more partially formed receptacles from respective ones of the first mould cavities 116 and carry them to respective ones of the second mould cavities 118 (assuming the partially formed receptacles are suitable to be transferred to the second mould cavities 118). To carry one or more partially formed receptacles, the first transfer device 106 comprises one or more contact surfaces. In more specific examples, the first transfer device 106 may comprise one or more vacuum contact surfaces, as will be explained below. It will be appreciated that in certain circumstances, references to one or more vacuum contact surfaces may be replaced by one or more contact surfaces.

The system 100 further comprises a second transfer device 108 that is configured to transfer one or more receptacles from the plurality of second mould cavities 118 to a further location, in the form of a conveyor belt 110. In this example, the second transfer device 110 is a robotic arm that is moveable within the system 100. The second transfer device 110 is configured to collect one or more receptacles from respective ones of the second mould cavities 118 and carry them to the conveyor belt 110. The conveyor belt 110 is configured to transfer the receptacles to another location within the facility, such as towards a further drying station or a coating station. To carry one or more partially formed receptacles, the second transfer device 108 may comprise one or more contact surfaces. In more specific examples, the second transfer device 108 comprises one or more vacuum contact surfaces, as will be explained below. It will be appreciated that in certain circumstances, references to one or more vacuum contact surfaces may be replaced by one or more contact surfaces.

FIG. 3 illustrates schematic examples of the first and second moulding stations 102, 104 and their arrangements relative to each other. As depicted, the first moulding station 102 comprises a plurality of first moulds 112, each first mould 112 having/defining a first mould cavity 116. As such, the system 100 comprises a plurality of first mould cavities 116. In this example, each of the first moulds 112 is porous to allow liquid, such as water, to escape during dewatering. In other examples, however, the first moulds 112 may be non-porous. The first moulds 112 may each correspond to the porous mould 15 of FIG. 1.

The second moulding station 104 comprises a plurality of second moulds 114, each second mould 114 having/defining a second mould cavity 118. As such, the system 100 comprises a plurality of second mould cavities 118. In this example, the second moulds 114 are porous. In other examples, however, the second moulds 116 are non-porous. The second moulds 114 may each correspond to the mould 25 of FIG. 1, and as such are heated to thermoform the receptacles. Partially formed receptacles transferred to the second mould cavities 118 can be processed within the second mould cavities 118, and such processing includes thermoforming the partially formed product by the application of heat and pressure, as discussed in relation to FIG. 1.

In this particular example, the total number of second mould cavities 118 (and therefore second moulds 114) is greater than the total number of the first mould cavities 116 (and therefore first moulds 112). More particularly, the total number of the second mould cavities 118 is twice the total number of the first mould cavities 116 because the time taken to form/process the receptacles in the second mould cavities 118 is approximately twice as long as the time taken to form the partially formed receptacles from the fibre suspension in the first mould cavities 116. In this example, there are four first mould cavities 116 and eight second mould cavities 118, but it will be appreciated that there may be a different ratio of second mould cavities 118 to first mould cavities in other examples. Further still, in other examples, the total number of second mould cavities 118 may be equal to the total number of the first mould cavities 116.

As shown in FIG. 3, the plurality of second moulds 114 (and therefore the second mould cavities 118) may be grouped into different subsets. In one example, the number of second mould cavities 118 in a subset is equal to the total number of first mould cavities 116. FIG. 3 therefore depicts a first subset 104a of the plurality of second mould cavities 118 and a second subset 104b of the plurality of second mould cavities 118. As will be explained in more detail below, the partially formed receptacles formed in the first mould cavities 116 may be transferred in batches by the first transfer device 106 to the first or second subsets 104a, 104b of the second mould cavities 118 once they have been formed. For example, the first transfer device 106 may transfer a first batch to the first subset 104a of second mould cavities 118 and later transfer a second batch to the second subset 104b of second mould cavities.

As shown in FIG. 3, the first mould cavities 116 are aligned along a first axis 132, and the second mould cavities 118 are aligned along a second axis 134. In this example, the first and second axes 132, 134, are coaxial, with the first and second mould cavities 116, 118 therefore being aligned along a common axis.

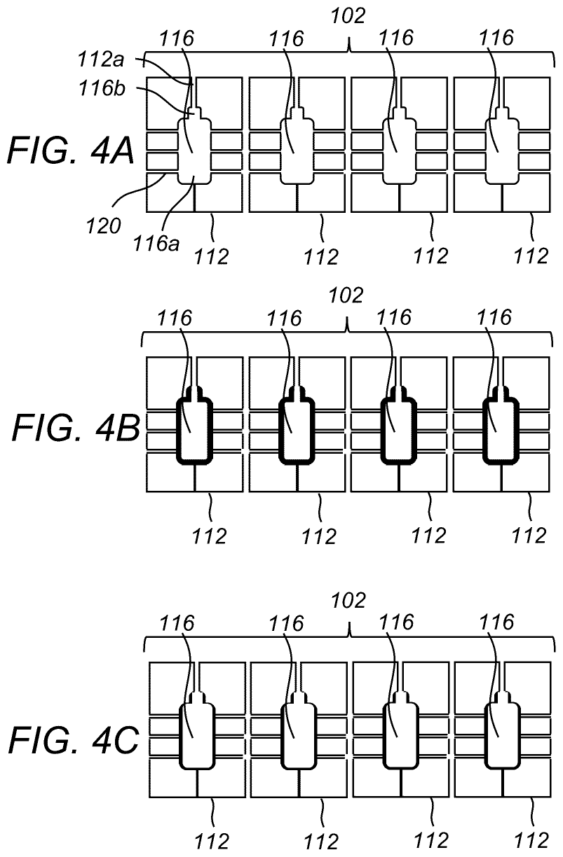

FIGS. 4A-C illustrate schematic examples of the first moulds 112 at different times during the dewatering process. FIG. 4A depicts the first moulds 112 before the fibre suspension has been introduced into the first mould cavities 116. FIG. 4B depicts the first moulds 112 after the fibre suspension has been introduced into the first moulds 112, and FIG. 4C depicts the first moulds 112 after compressed air has been introduced into the first moulds 112 to compress the fibre suspension against the cavity wall of the first moulds 112.

In more detail, FIG. 4A depicts the first moulds 112 formed from two separate half-moulds. When the two half-moulds are brought together, the half-moulds form a first mould cavity 116 in the first moulds 112.

FIG. 4A depicts apertures 120 in/through the first moulds 112 and into the first mould cavities 116. As mentioned earlier, these apertures 120 allow liquid to pass through. In FIG. 4A, the cavities 116 are “empty” since the fibre suspension has not yet been supplied to the first moulds 112. The first moulds 112 are formed such that there is an opening 112a into the first mould cavities 116. Fibre suspension is introduced into the first mould cavities 116 via the opening 112a. Similarly, compressed air is introduced into the first mould cavities 116 via the opening 112a.

In the example of FIG. 4A, each first mould cavity 116 has a main body portion 116a (also known as a first portion) and a neck portion 116b (also known as a second portion). The neck portion 116b may be used to form the neck of the receptacle/bottle. Between the main body portion 116a and the neck portion 116b is a shoulder portion in this example. Thus, the receptacle itself is formed having a neck portion, a main body portion and a shoulder portion, in this example.

FIG. 4B depicts the first moulds 112 at a later time. Here, the fibre suspension has been drawn into the first mould cavities 116 via the cavity openings under vacuum and the fibre suspension coats the mould cavity wall to form a loose receptacle shape. Liquid may be extracted or drained through the apertures 120. At this point, the fibre suspension coating/layer has an initial thickness on the cavity wall.

After the fibre suspension has been applied to the mould cavity wall in this way, compressed air is introduced into the first mould cavities 116 to compress the fibre suspension layer on the mould cavity wall as the vacuum is applied to the mould via the apertures 120. This presses/compacts the fibre suspension layer and helps to drive out liquid. This liquid may then pass through the apertures 120. In other examples, an inflatable bladder may be used in place of compressed air, as described above.

FIG. 4C shows partially formed receptacles formed inside the first mould cavities 116 of the moulds 112. The fibre suspension has been compacted to form a layer (i.e., a wall of the partially formed receptacle). The layer is therefore thinner than depicted in FIG. 4B. From here, the split-moulds 112 may be opened, allowing the first transfer device 106 to transfer the partially formed receptacles to the second mould cavities 118 for further processing. As mentioned, this further processing involves thermoforming (i.e., applying heat and pressure to) the partially formed receptacle to form the receptacle.

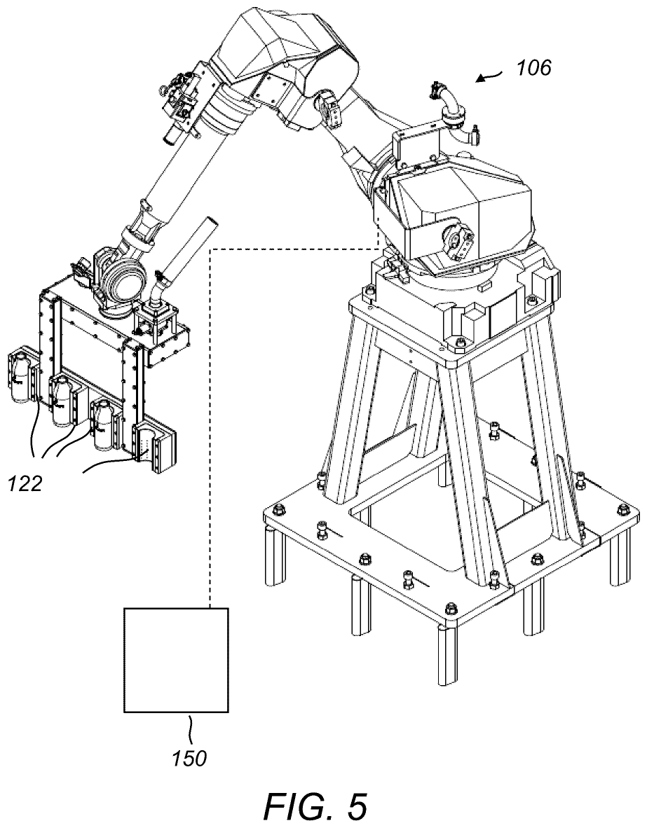

FIG. 5 depicts an example transfer device. The transfer device of this example is the first transfer device 106 shown in FIG. 2. The second transfer device 108 is generally the same as the first transfer device 106 (in some examples with differently shaped/profiled vacuum contact surfaces), so the following discussion applies equally to the second transfer device 108 carrying receptacles. The second transfer device 108 therefore also comprises a plurality of vacuum contact surfaces 128. As mentioned, the transfer device 106 is a robotic arm moveable within the system 100 to collect and deposit partially formed receptacles. The transfer device 106 is communicatively coupled to a controller 150 (a hollow-moulded-fibre-product-manufacturing-system controller), that executes instructions to control the actions of the transfer device 106 and other components of the system 100. For example, the instructions may instruct the transfer device 106 to collect, move and then deposit a partially formed receptacle. The transfer device 106 in this example can move one or more partially formed receptacles in three dimensions. Other transfer devices may be more limited in their movement capabilities, for example only moving in two dimensions. In other examples, the transfer device comprises the controller 150.

As shown, the transfer device 106 comprises a plurality of vacuum contact surfaces 122. The transfer device 106 is configured to apply a vacuum to each vacuum contact surface 122 to apply an attractive force (i.e., suction) to a partially formed receptacle to enable the partially formed receptacle to be carried/transferred. FIG. 5 shows three partially formed receptacles held in contact with three vacuum contact surfaces 122. One additional vacuum contact surface 122 is shown not holding a partially formed receptacle 122 for illustrative purposes, but it will be appreciated that the transfer device 106 may also hold four partially formed receptacles in contact with the four vacuum contact surfaces 122. In examples, the vacuum contact surfaces 122 may form part of an end effector of the transfer device 106. In some examples, the vacuum can be removed, or reversed such that a positive pressure is applied to a partially formed receptacle to move the partially formed receptacle away from the vacuum contact surface 122. In certain examples, the transfer device 106 does not have vacuum contact surfaces, but instead has one or more contact surfaces that can hold one or more partially formed receptacles by other means.

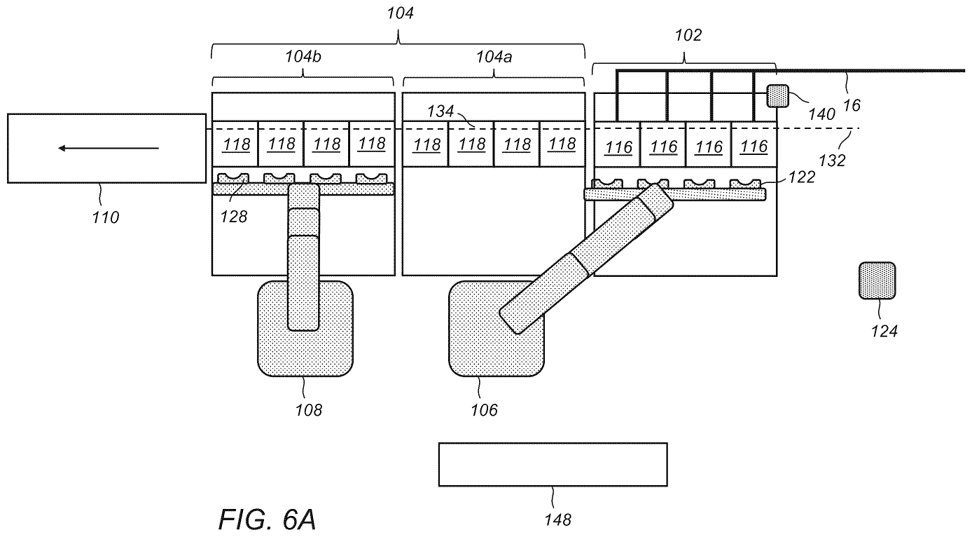

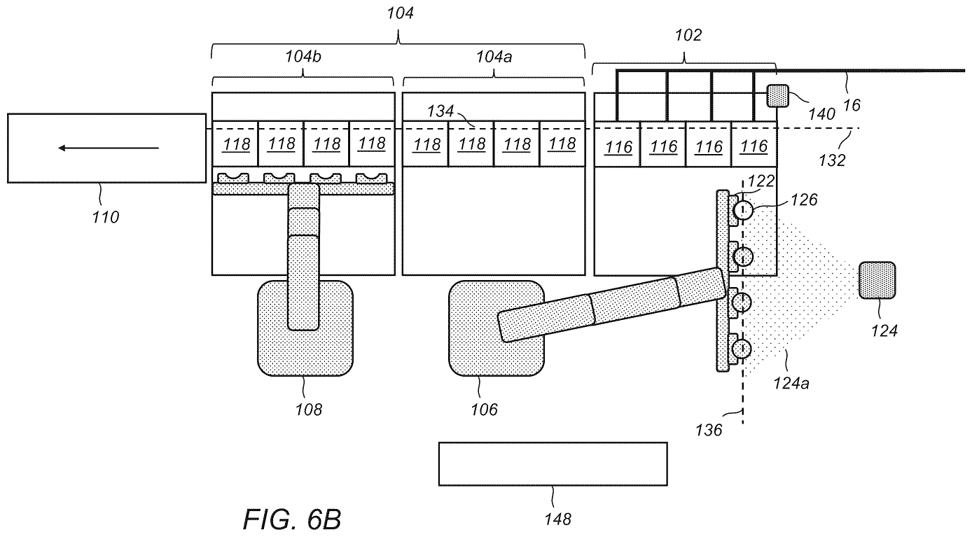

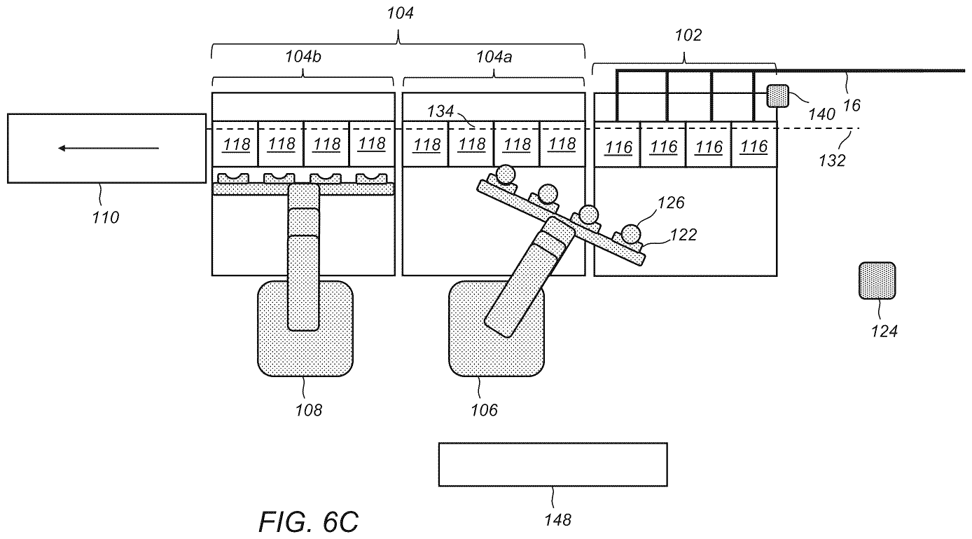

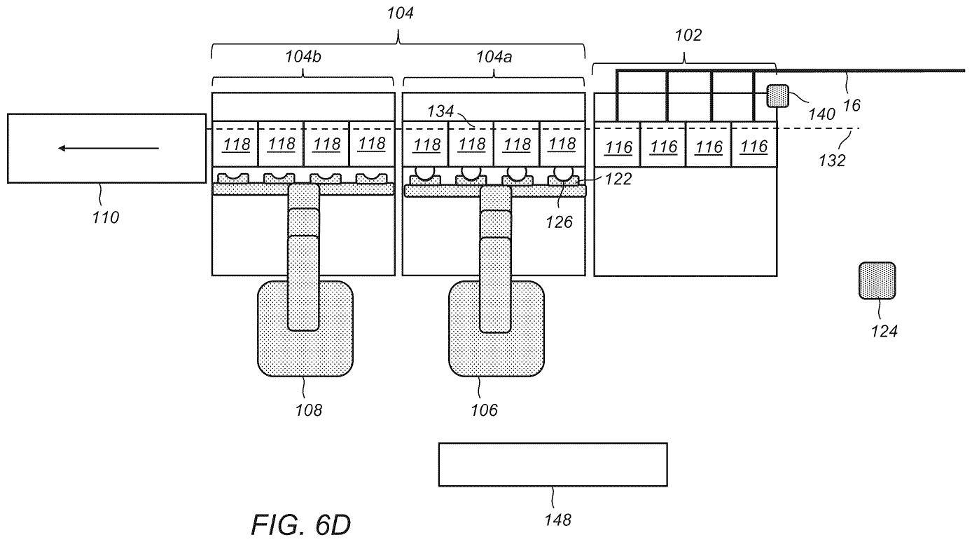

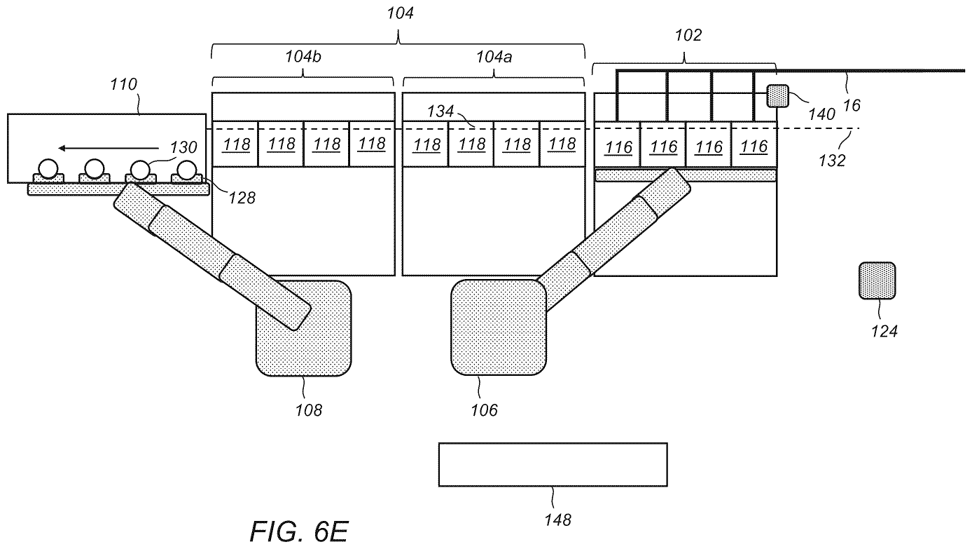

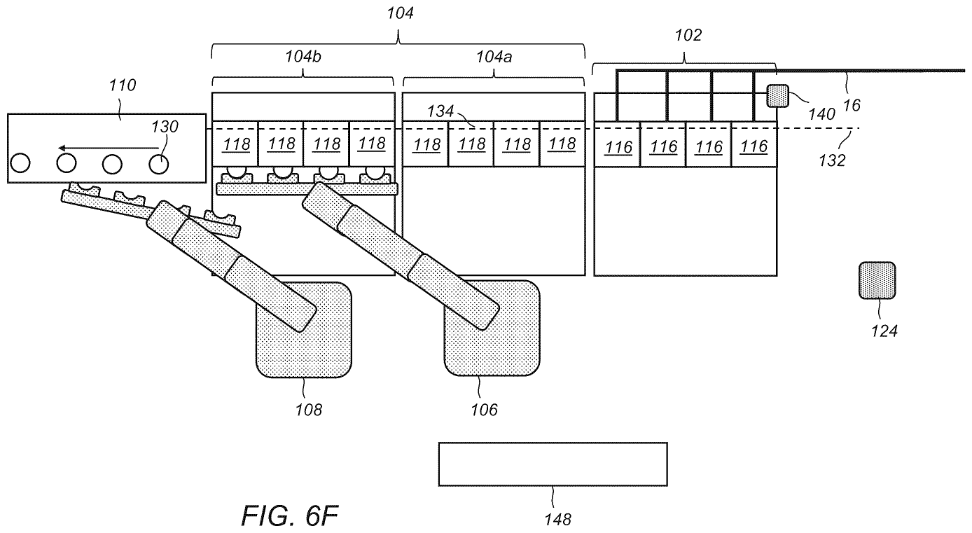

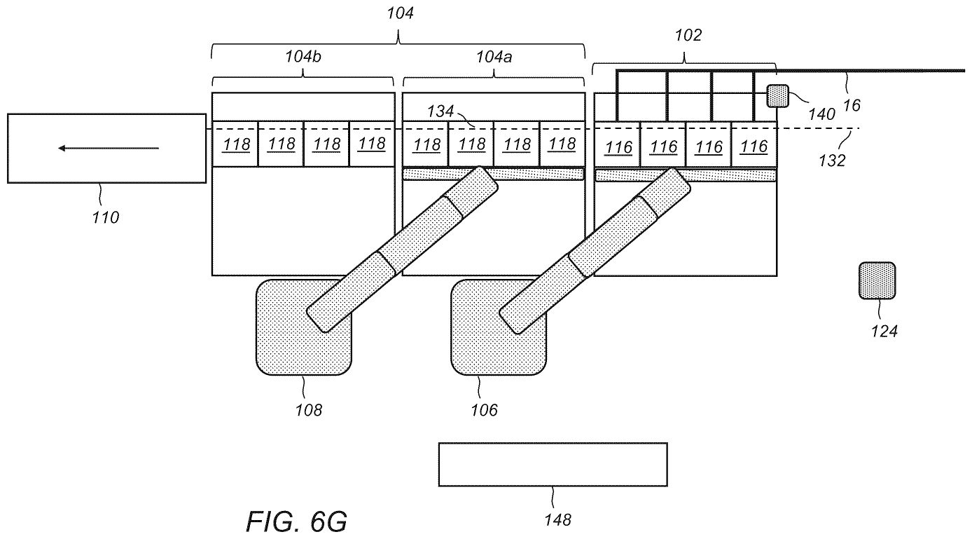

FIG. 6A depicts a schematic top-down view of the system 100 at a first time. At this moment in time, the plurality of first mould cavities 116 have each received the fibre suspension (via the lines 16) and compressed air has been introduced into each first mould cavity 116 to compress the fibre suspension. The first transfer device 106 is not yet carrying any of the partially formed receptacles, and is instead waiting to collect the partially formed receptacles from the plurality of first mould cavities 116. FIG. 6A shows the vacuum contact surfaces 122 of the first transfer device 106 before contacting the outer surfaces of the partially formed receptacles.

FIG. 6A also depicts the second transfer device 108 waiting to collect receptacles from the plurality of second mould cavities 118. The receptacles being formed in the second subset 104b of the second mould cavities 118 have been transferred there by the first transfer device 106 at an earlier time. As such, the second transfer device 108 is not yet carrying any of the formed receptacles. FIG. 6A shows second vacuum contact surfaces 128 of the second transfer device 108 before contacting the outer surfaces of any receptacles.

As shown in FIG. 6A, the first axis 132 and the second axis 134 are coaxial, with the first and second mould cavities 116, 118 therefore being aligned along a common axis. This facilitates access to the rear of the cavities 116, 118 for maintenance for example.

FIG. 6B depicts a schematic top-down view of the system 100 at a second time. At this moment in time, the first transfer device 106 has collected the partially formed receptacles 126 from the plurality of first mould cavities 116 and is in the process of transferring the partially formed receptacles 126 to the plurality of second mould cavities 118. In a particular example, the entire process of forming the partially formed receptacles 126 in the first mould cavities 116 takes approximately 60 seconds. In other examples, forming the partially formed receptacles 126 in the first mould cavities 116 takes less than 90 seconds, or between 30 seconds and 90 seconds, or between 30 seconds and 60 seconds, such as between 40 and 60 seconds.

To collect the partially formed receptacles 126 from the first mould cavities 116, the first moulds 112 are opened/split to reveal the partially formed receptacles 126 formed therein. Once the partially formed receptacles 126 are accessible, the first transfer device 106 first moves the vacuum contact surfaces 122 towards the partially formed receptacles 126 held within the first mould cavities 116. In some cases, the first transfer device 106 stops at a position in which the vacuum contact surfaces 122 do not contact outer surfaces of the partially formed receptacles 126 when they are contained within the first mould cavities 116. In other cases, the first transfer device 106 moves to a position in which the vacuum contact surfaces 122 do contact outer surfaces of the partially formed receptacles 126. In either case, a vacuum is applied to the vacuum contact surfaces 122, which causes the partially formed receptacles 126 to be drawn towards and retained against the vacuum contact surfaces 122. In examples where the first mould cavities 116 are applying a vacuum to the partially formed receptacles 126 within the mould cavities 116, the vacuum may be removed (or at least reduced) as the vacuum is applied to the vacuum contact surfaces 122 so that the partially formed receptacles 126 are drawn towards the vacuum contact surfaces 122. For example, a greater negative pressure (i.e., a stronger vacuum) may be applied to the vacuum contact surfaces 122 than is applied to the first mould cavities 116, which draws the partially formed receptacles 126 towards the vacuum contact surfaces 122. In another example, a positive pressure is applied by the first mould cavities 116 to urge the partially formed receptacles 126 out of the first mould cavities 116 and towards the vacuum contact surfaces 122.

In cases where the partially formed receptacles 126 do not contact the vacuum contact surfaces 122 as they are being collected from the first mould cavities 116, the action of the vacuum(s) and/or the positive pressure applied by the first mould cavities 116, may cause the partially formed receptacles 126 to “jump” across the gap (i.e., between the vacuum contact surfaces 122 and the first mould cavities 116) without being in contact with any surface during this manoeuvre.

FIG. 6B then depicts the system after the vacuum contact surfaces 122 (and therefore the partially formed receptacles 126) have been moved relative to (i.e., away from) the first mould cavities 116. During this movement, the vacuum remains applied to the vacuum contact surfaces 122 such that the partially formed receptacles 126 are retained in contact with the vacuum contact surfaces 122. Through the use of such a vacuum, the first transfer device 106 carries the partially formed receptacles 126 from a first location (i.e., from within the first mould cavities 116) and towards a particular location (such as the second mould cavities 118).

Once a first batch of partially formed receptacles 126 have been formed in, and then removed from, the plurality of first mould cavities 116, a second batch of partially formed receptacles 126 may be formed in the same first mould cavities 116. As such, fibre suspension may again be introduced into the first mould cavities 116. This further batch of partially formed receptacles 126 will be collected by the first transport device 106 at a later time.

As shown in FIG. 6B, the first transfer device 106 is configured to simultaneously transfer two or more (i.e., a plurality of) partially formed receptacles 126 from the plurality of first mould cavities 116 to the plurality of second mould cavities 118. In this particular example, the first transfer device 106 is configured to simultaneously transfer all the partially formed receptacles 126 (in this case four) from the plurality of first mould cavities 116 to the plurality of second mould cavities 118. In this example, the first transfer device 106 has a vacuum contact surface 122 corresponding to each first mould cavity 116 in the first moulding station 102.

Furthermore, as shown, the vacuum contact surfaces 122 are also aligned along a third axis 136, and so the two or more partially formed receptacles 126 are aligned along the third axis 136 on the first transfer device 106 when carried by the vacuum contact surfaces 122. Due to the movement capabilities of the first transfer device 106, the third axis 136 is moveable relative to the first and second axes 132, 134, and can be moved into positions such that the third axis 136 is coincident with the first and second axes 132, 134. For example, when the first transfer device 136 collects the partially formed receptacles 126 from the first mould cavities 116, the first and third axes 132, 136 are coincident. Similarly, as will become apparent from the discussion below, when the first transfer device 136 deposits the partially formed receptacles 126 in the second mould cavities 118, the second and third axes 134, 136 are coincident.

FIG. 6B further depicts an inspection system 124 configured to inspect the partially formed receptacles 126 to obtain/determine a state of the partially formed receptacles 126 after the first transfer device 106 has moved the vacuum contact surfaces 122 away from the first mould cavities 116, and before the transfer device 106 has deposited any of the partially formed receptacles 126 in the plurality of second mould cavities 118. The inspection system 124 therefore inspects the partially formed receptacles 126 during their transition between the first and second mould cavities 116, 118. In some examples, the inspection system 124 may be omitted.

The state of a partially formed receptacle 126 may indicate the condition and/or position and/or presence of the partially formed receptacle 126. The state may be used to determine if, how and where the partially formed receptacles 126 are to be deposited.

In some examples, the inspection system 124 comprises one or more image capture devices, such as one or more cameras, to capture one or more images of the partially formed receptacles 126 as they are being held by the first transfer device 106. In this specific example, there is a single image capture device to capture one or more images. The state of the partially formed receptacles 126 can therefore be determined based on the image(s). FIG. 6B shows the field of view 124a of the inspection system. The field of view 124a of the inspection system 124 may be wide enough so that the inspection system 124 can simultaneously inspect two or more of the partially formed receptacles 126 being held by the first transfer device. In this case, the inspection system can inspect all the partially formed receptacles 126 on the first transfer device 106.

As an example, the inspection system 124 may determine that one of: (i) a partially formed receptacle 126 is unsuitable for transfer to a second mould cavity 118 (for example, the partially formed receptacle 126 may be malformed/damaged), (ii) a partially formed receptacle 126 is suitable for transfer to the second mould cavity 118 (for example, the partially formed receptacle 126 may be formed correctly), (iii) a partially formed receptacle 126 is not present on a vacuum contact surface (i.e., it has been dropped or left behind in a first mould cavity 116), (iv) a partially formed receptacle 126 requires human inspection (to perhaps determine the state manually and/or to reposition or remove a partially formed receptacle 126), or (v) a partially formed receptacle 126 is offset/misaligned on the vacuum contact surface 122. Other states may also be possible.

In some examples, the inspection system 124 transmits data indicative of one or more partially formed receptacles 126 to a remote server (not shown) for processing by the remote server, which data is recorded/determined by the inspection system 124. For example, the inspection system 124 may transmit one or more images of the partially formed receptacle(s) 126 to the remote server for analysis. The remote server may process/analyse the data (such as performing object recognition or other image processing techniques), and on the basis of the data, determine one or more states of one or more partially formed receptacles 126 associated with the data. Once the one or more states have been determined, the remote server may transmit data indicative of the one or more states to the inspection system 124. The system 100 can then act upon the one or more states received from the remote server. In alternative examples, the inspection system 124 itself determines the states of the partially formed receptacles 126.

In examples, based on the determined state(s) of the partially formed receptacles 126, the system 100 (such as the first transfer device 106 itself) may perform a particular action. For example, the first transfer device 106 may be configured to one of: (i) move the vacuum contact surfaces 122 back to towards the first mould cavities 116 to collect one or more partially formed receptacles 126 that have been left behind in the first mould cavities 116, (ii) deposit one or more damaged and/or misaligned partially formed receptacles 126 at a different location instead of in the second mould cavities 118, (iii) move the vacuum contact surfaces 112 towards a different location to deposit one or more damaged and/or misaligned partially formed receptacles 126 at the different location instead of in the second mould cavities 118, (iv) await human inspection before taking a further action, (v) move the vacuum contact surfaces 122 towards a different location to await human inspection, or (vi) move the vacuum contact surfaces 122 towards the second mould cavities 118 to deposit the partially formed receptacles 126 in the second mould cavities 118 (for example if the partially formed receptacles 126 are deemed suitable for transfer to the second mould cavities 118).

In some examples, the system 100 may perform the action, in addition to or instead of an action performed by the first transfer device 106. For example, the system may output a notification to indicate a particular state. For example, if a partially formed receptacle 126 is damaged, a sound and/or light may be output by a notification system 140. In another example, data indicative of a notification may be displayed by a terminal such as a user interface to alert a human operator that there is a problem and/or manual intervention is required. Data may also/alternatively be stored in memory.

In another example, the system may cause a cleaning assembly (not shown) to perform a cleaning operation on the first mould cavity and/or the vacuum contact surface of the transfer device. For example, if the partially formed receptacle (or part of the partially formed receptacle) is stuck or left behind in the first mould cavity, cleaning may be required.

In one example, a state is determined for (and assigned to) each partially formed receptacle 126 being carried/held by the first transfer device 106. For example, one partially formed receptacle 126 may have a state indicating that it is not suitable for transfer to a second mould cavity 118, and the remaining partially formed receptacles 126 may have states indicating that they are suitable for transfer to second mould cavities 118. Accordingly, in certain examples, a state is determined for each partially formed receptacle 126 and one or more actions may be performed by the system (such as the first transfer device 106) based on those states. For example, if one partially formed receptacle 126 is determined to be unsuitable for transfer to a second mould cavity 118, a corresponding action may be taken for that partially formed receptacle, and if another partially formed receptacle 126 is deemed suitable for transfer to a second mould cavity 118, a corresponding action may be taken for that partially formed receptacle 126. In a particular example, if one partially formed receptacle is determined to be unsuitable for transfer to a second mould cavity 118, the partially formed receptacle 126 may be deposited at different location and not in a second mould cavity 118, while any other partially formed receptacles 126 are deposited within respective second mould cavities 118.

In other examples, a state may be initially determined for (and assigned to) each partially formed receptacle 126 but based on those states, a single state may be applied to all the partially formed receptacles 126 being held by the first transfer device. For example, if one of the partially formed receptacles 126 is deemed unsuitable for transfer to a second mould cavity 118, while the remaining partially formed receptacles 126 are suitable for transfer to second mould cavities 118, then all of the partially formed receptacles may be associated with a state indicating that they are unsuitable for transfer to second mould cavities 118. This may be the case when the first transfer device 106 is unable to take separate actions for each individual partially formed receptacle 126.

As mentioned, if the state of a partially formed receptacle 126 is such that it is not deemed suitable to be deposited in a second mould cavity 118, the partially formed receptacle 126 may be deposited at a different (i.e., another) location. In one example, to deposit a partially formed receptacle 126 at another location, the vacuum applied to the vacuum contact surface 122 against which the partially formed receptacle 126 is being held, may be removed or reduced, thereby causing the partially formed receptacle to be deposited at that location. In another example, a positive pressure (such as a blast of air) may be applied to the partially formed receptacle (via the vacuum contact surface) which causes the partially formed receptacle 126 to be dropped/deposited by the first transfer device 106. In some cases, the partially formed receptacle 126 may be deposited at the location in which the inspection system 124 inspected the partially formed receptacle 126 (such as at the location shown in FIG. 6B). In another example, the first transfer device may first move the vacuum contact surface 122 to a different location before depositing the partially formed receptacle 126 at that location. A bin/container 148, a conveyor belt, or a chute may collect the partially formed receptacle 126 that is deposited by the first transfer device 126. The deposited partially formed receptacles 126 may be recycled, in some examples.

In the example of FIG. 6B the first transfer device 106 is configured to stop at a particular location (i.e., the location shown in FIG. 6B), relative to the inspection system 124, while the inspection system 124 inspects the partially formed receptacles 126. In other examples, rather than stopping, the first transfer device 106 may continue moving relative to the inspection system 124 while the inspection system 124 inspects the partially formed receptacles 126.

As shown in FIG. 6B, the inspection system 124 is arranged on one side of the first moulding station 102 and the second moulding station 104 is arranged on the other side of the first moulding station 102. Accordingly, after collecting the partially formed receptacles 126, the first transfer device 106 moves the vacuum contact surfaces 122 away from both the first and second mould cavities 116, 118 and towards the inspection system 124. This arrangement may be useful so that any faulty/damaged receptacles can be immediately removed/deposited while at this location, without requiring any further movement by the first transfer device 106.

As discussed, FIG. 6B depicts the first transfer device 106 presenting the partially formed receptacles 126 to the inspection system 124 such that the inspection system 124 is able to obtain respective states of the partially formed receptacles 126. As is also shown, to improve the likelihood of accurately determining and assessing the state of the partially formed receptacles, it is preferred that the field of view 124a and/or the vacuum contact surfaces 122 are such that at least 40% of the surface area of each partially formed receptacle 126 is visible by the inspection system 124 when the inspection system inspects the partially formed receptacle 126 to obtain its state. This requires, for example, each vacuum contact surface 122 to contact/cover no more than about 60% of the surface area of each partially formed receptacle 126.

In some examples, the inspection system 124 inspects the partially formed receptacles 126 from two or more different viewpoints before determining the state(s). For example, the first transfer device 106 may rotate and/or tilt relative to the inspection system 124 so that a greater portion of the outer surface of each partially formed receptacle 126 can be inspected by the inspection system 124.

Assuming at least one partially formed receptacle 126 is deemed suitable for transfer to a second mould cavity 118, the first transfer device 106 then moves the contact surfaces 122 towards the second mould cavities 118 to deposit the one or more partially formed receptacles 126 in second mould cavities 118, ready for further processing. FIG. 6C therefore depicts a schematic top-down view of the system 100 at a third time. At this moment in time, the first transfer device 106 is moving the partially formed receptacles 126 towards the plurality of second mould cavities 118 to deposit the partially formed receptacles 126 in respective second mould cavities 118. For example, it may have been determined that all of the partially formed receptacles 126 are suitable to be deposited in the second mould cavities 118.

FIG. 6D depicts a schematic top-down view of the system 100 at a fourth time. At this moment in time, the first transfer device 106 is moving the partially formed receptacles 126 towards the plurality of second mould cavities 118 and the partially formed receptacles 126 are shown entering respective second mould cavities 118.

As shown in FIG. 6D, the first transfer device 106 is in the process of transferring the partially formed receptacles 126 to the first subset 104a of the plurality of second mould cavities 118. As will become apparent, the next batch of partially formed receptacles currently being formed in the first mould cavities 116 will be transferred to the second subset 104b of the plurality of second mould cavities 118. Furthermore, as already mentioned, an earlier batch of partially formed receptacles was transferred to the second subset 104b at an earlier time. The first transfer device 106 therefore alternates between transferring the partially formed receptacles to the first and second subsets 104a, 104b of the second mould cavities 118.

To deposit the partially formed receptacles 126 in the second mould cavities 118, the second moulds 114 are opened/split (if they aren't already open) to reveal the empty second mould cavities 118 therein. In this example, the first transfer device 106 moves the vacuum contact surfaces 122 (and therefore the partially formed receptacles 126) towards the second mould cavities 118. In some examples, the first transfer device 106 stops at a position in which the partially formed receptacles 126 do not contact the inner surface of the second mould cavities 118, but in other examples, the first transfer device 106 stops at a position in which the partially formed receptacles 126 do contact the inner surface of the second mould cavities 118. From here, the first transfer device 106 then one of: (i) removes or reduces the vacuum applied to the vacuum contact surfaces 122 and/or (ii) applies a positive pressure to the partially formed receptacles 126 on the vacuum contact surfaces 122 to urge the partially formed receptacles 126 away from the vacuum contact surfaces 122. Applying a positive pressure requires blowing air out of a vacuum contact surface 122 to “blow” the partially formed receptacle 126 away from the vacuum contact surface 122. The partially formed receptacles 126 are therefore deposited in the second mould cavities 118. In cases where the partially formed receptacles 126 do not contact the inner surface of the second mould cavities 118, the partially formed receptacles 126 may “jump” across the gap (i.e., between the vacuum contact surfaces 122 and the second mould cavities 118) without being in contact with any surface during this manoeuvre.

In some examples, a vacuum may be applied to each of the second mould cavities 118. This may be to help form the receptacles within the second mould cavities, to move additional liquid from the partially formed receptacles 126, and/or to aid transfer of the partially formed receptacles 126 between vacuum contact surfaces 122 and the second mould cavities 118 via suction. As such, in certain examples, the first transfer device 106 may be configured to move the vacuum contact surfaces 122 towards the second mould cavities 118 and one of: (i) remove or reduce the vacuum applied to the vacuum contact surfaces 122, (ii) apply a positive pressure to the partially formed receptacles 126 on the vacuum contact surfaces 122 to urge/push the partially formed receptacles 126 towards the second mould cavities 118, or (iii) apply a greater negative pressure to the second mould cavities 118 than a negative pressure applied to the vacuum contact surfaces 122 to draw/pull the partially formed receptacles 126 towards the second mould cavities 118.

FIG. 6E depicts a schematic top-down view of the system 100 at a fifth time. At this moment in time, the first transfer device 106 has deposited the partially formed receptacles 126 in the respective second mould cavities 118 (of the first subset 104a) and has moved away from the second mould cavities 118 to collect further partially formed receptacles 126 that are, or have been, formed in the plurality of first mould cavities 116. For example, the controller 150 may determine that further partially formed receptacles 126 are ready to be transferred to the second subset 104b of the plurality of second mould cavities 118. A signal to instruct collection from the plurality of first mould cavities 116, for example, may be received by the first transfer device 106. The signal may be sent when moulding in the first mould cavities 116 is about to be, or is, complete. In other examples, the first transfer device 106 may be configured to return to the first mould cavities 116 to collect the further partially formed receptacles 126 after a predetermined period of time.

FIG. 6E also depicts the second transfer device 108 having collected, and subsequently transferred/carried, formed receptacles 130 from the plurality of second mould cavities 118 (in this case, from the second subset 104b of the plurality of second mould cavities 118). As discussed, these receptacles 130 were being thermoformed within the second subset 104b of the second mould cavities 118 during the time period of FIGS. 6A-D. In a particular example, the entire process of forming the receptacles 130 in the second mould cavities 118 takes approximately 120 seconds. Due to the time for forming the receptacles 130 in the second mould cavities 118 being approximately twice the time for forming the partially formed receptacles 126 in the first mould cavities 116, there are twice as many second moulds and second mould cavities 118 as first moulds and first mould cavities 116. In other examples, forming the receptacles 130 in the second mould cavities 118 takes less than 180 seconds, or between 60 seconds and 180 seconds, or between 60 seconds and 150 seconds, such as between 60 seconds and 120 seconds.

As with the first transfer device 106, the second transfer device 108 is also configured to simultaneously transfer two or more (i.e., a plurality of) receptacles 130 from the plurality of second mould cavities 118 to a further location. In this particular example, the second transfer device 108 is configured to simultaneously transfer all the receptacles 130 from the plurality of second mould cavities 118. Furthermore, in this example, there is a vacuum contact surface 128 corresponding to each second mould cavity 118 in each subset 104a, 104b of the plurality of second mould cavities 118.

The second transfer device 108 collects the receptacles 130 in the same or similar fashion to that discussed above in relation to the first transfer device 106. For example, to collect the receptacles 130 from the second mould cavities 118, the second moulds 114 are opened/split to reveal the receptacles 130 formed therein. Once the receptacles 130 are accessible, the second transfer device 108 first moves the second vacuum contact surfaces 128 towards the receptacles 130 held within the second mould cavities 118. From here, a vacuum is applied to the second vacuum contact surfaces 128, which causes the receptacles 130 to be drawn towards and retained against the second vacuum contact surfaces 128. In some examples, a vacuum may be applied to each of the second mould cavities 118, and the vacuum may be controlled (such as reduced or removed) as the second vacuum contact surfaces 128 collect the respective receptacles 130 from the second mould cavities 118.

FIG. 6E depicts the system after the second vacuum contact surfaces 128 have been moved relative to the second mould cavities 118. During this movement, the vacuum remains applied to the second vacuum contact surfaces 128 such that the receptacles 130 are retained in contact with the second vacuum contact surfaces 128, meaning that the second transfer device 108 can carry the receptacles 130 towards a further location (in this case, the moving surface of the conveyor belt 110).

FIG. 6F depicts a schematic top-down view of the system 100 at a sixth time. At this moment in time, the first transfer device 106 has collected further partially formed receptacles 126 from the plurality of first mould cavities 116 and is in the process of transferring the partially formed receptacles 126 to the plurality of second mould cavities 118 (in this case, the second subset 104b of second mould cavities 118).

FIG. 6F also depicts the second transfer device 108 after having deposited the receptacles 130 on the conveyor belt 110. To deposit the receptacles 130 on the moving surface (i.e., the conveyor belt 110), in one example, the second transfer device 108 is configured to stop the second vacuum contact surfaces 128 at a position in which the receptacles 130 do not contact the moving surface 110. From here, the second transfer device 108 is configured to one or more of: (i) remove or reduce the vacuum applied to the second vacuum contact surfaces 128 such that the receptacles 130 are deposited on the moving surface 110, and/or (ii) apply a positive pressure to the receptacles 130 on the second vacuum contact surfaces 128 to urge the receptacles 130 away from the second vacuum contact surfaces 128. In either case, the receptacles 130 are deposited on the moving surface 110. For example, the receptacles 130 may land on the conveyor belt 110 and be carried away to another location for additional processing.

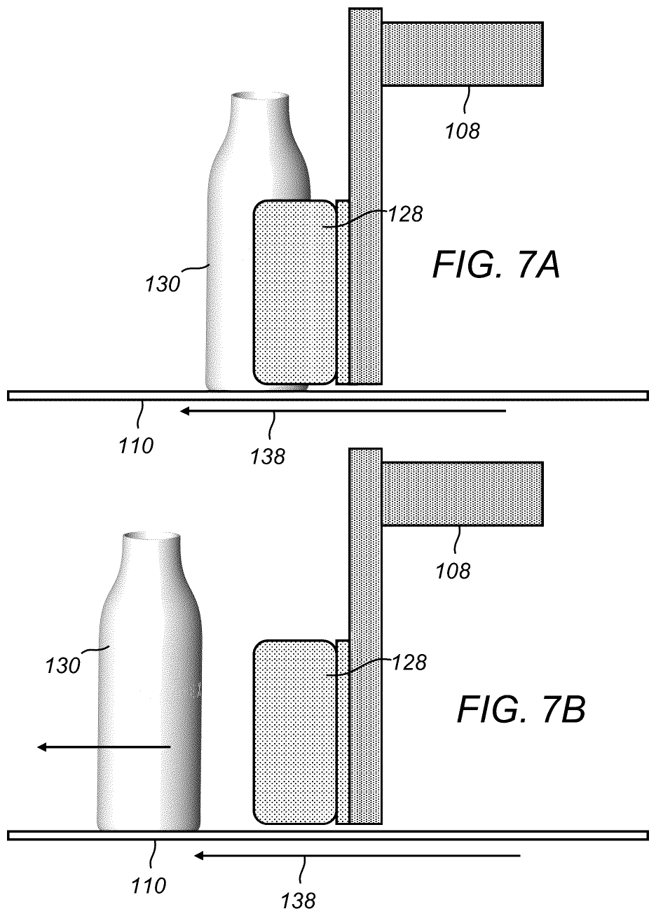

In alternative examples (or in examples where one or more receptacles 130 are “stuck” to the vacuum contact surface 128, despite the previous operation) the second transfer device 108 may be configured to move the second vacuum contact surfaces 128 to a position in which the receptacles 130 contact the moving surface 110 and the movement of the moving surface 110 causes the receptacles to be drawn away from the second vacuum contact surfaces 128. Such an example is shown illustratively in FIGS. 7A and 7B. In particular, FIG. 7A shows a receptacle 130 in contact with the moving surface 110 (the movement direction of the surface 110 being shown by arrow 138). FIG. 7B shows the receptacle 130 being carried away from the second vacuum contact surface 128. In some cases, the second transfer device 108 may also remove or reduce the vacuum applied to the second vacuum contact surfaces 128 or apply a positive pressure to receptacles 130 to urge the receptacles 130 away from the second vacuum contact surfaces 128.

FIG. 6G depicts a schematic top-down view of the system 100 at a seventh time. At this moment in time, the first transfer device 106 has deposited the further partially formed receptacles 126 in the respective second mould cavities 118 and has moved away from the second mould cavities 118 to collect further partially formed receptacles 126 that are, or have been, formed in the plurality of first mould cavities 116.

FIG. 6G also depicts the second transfer device 108 waiting to collect receptacles from the plurality of second mould cavities 118, these receptacles being those formed from the partially formed receptacles deposited in FIG. 6D. As such, the second transfer device 108 is not yet carrying any of the formed receptacles. Once collected from the first subset 104a of second mould cavities 118, the receptacles 130 will be transferred by the second transfer device 108 to a further location, such as the conveyor belt 110.

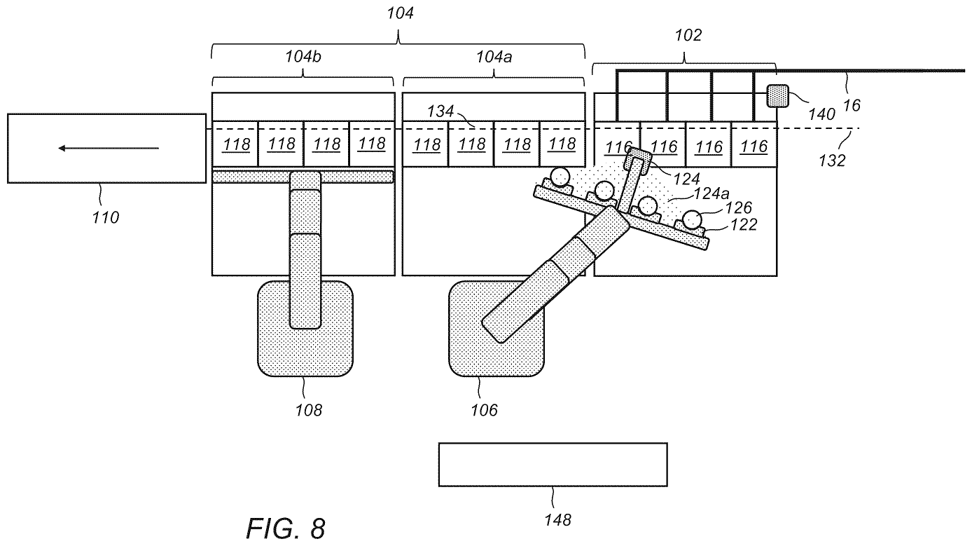

FIG. 8 depicts an alternative (or additional) inspection system 124 to that shown in FIGS. 6A-6G. In contrast to the inspection system shown in FIGS. 6A-6G, the inspection system 124 of FIG. 8 is affixed to the first transfer device 106. The inspection system 124 is therefore in a fixed position relative to the vacuum contact surfaces 122 such that the inspection system 124 moves with the vacuum contact surfaces 122 as the vacuum contact surfaces 122 are moved by the first transfer device 106.

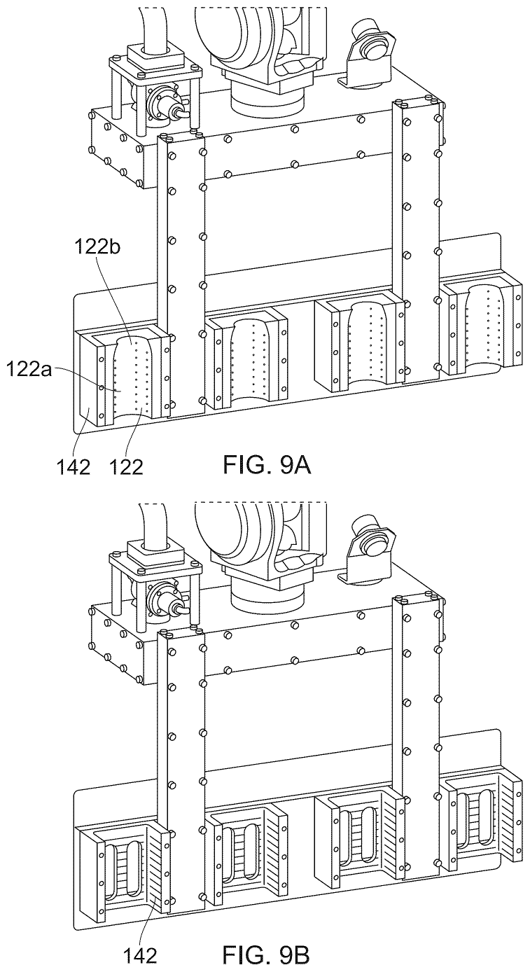

FIG. 9A depicts a perspective view of part of the first transfer device 106. As shown, the first transfer device 106 comprises a plurality of vacuum contact surfaces 122 (in this case four) aligned along an axis. Each vacuum contact surface 122 is shaped to conform to a partially formed receptacle 126, and thus has a three-dimensional surface profile to correspond to a three-dimensional surface profile of a portion of an outer surface of the partially formed receptacle 126. In this example, the vacuum contact surface 122 is curved/convex to match the concave/curved nature of the partially formed receptacle 126. As such, the three-dimensional vacuum contact surface may correspond to the three dimensional surface profile of the partially formed receptacle 126. As shown in this example, the three-dimensional surface profile of each vacuum contact surface 122 corresponds to a three-dimensional surface profile of a main body portion and a shoulder portion of the partially formed receptacle 126. Each vacuum contact surface 122 therefore has a main body portion 122a and a shoulder portion 122b to contact the main body portion and shoulder portion of a partially formed receptacle 126 respectively. Not contacting the delicate neck portion of the partially formed receptacle 126 can avoid damaging the partially formed receptacle 126 as it is being transferred by the first transfer device 106 and supporting the shoulder portion can provide greater support for the neck portion and the partially formed receptacle 126 overall. That said, in other examples, the three-dimensional vacuum contact surface may additionally correspond to a neck portion of the partially formed receptacle 126. FIG. 9B depicts a perspective view of part of the first transfer device 106 with the vacuum contact surfaces 122 removed from respective holders 142 of the first transfer device 106. Each vacuum contact surface 122 may therefore be removable from the first transfer device 106. For example, each vacuum contact surface 122 may couple with each holder 142 via a fastener. Different sized/shaped vacuum contact surfaces 122 may be selected and coupled to the holders 142 depending on the type of receptacle being manufactured and thus to be transported by the first transfer device 106.

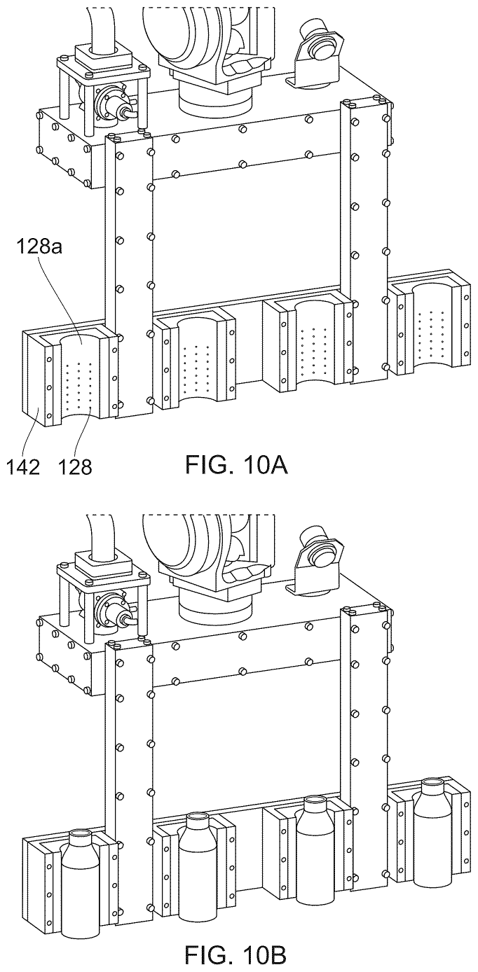

FIG. 10A depicts a perspective view of part of the second transfer device 108. As shown, the second transfer device 108 comprises a plurality of vacuum contact surfaces 128 (in this case four) aligned along an axis. Each vacuum contact surface 128 is shaped to conform to a receptacle 130, and thus has a three-dimensional surface profile to correspond to a three-dimensional surface profile of a portion of an outer surface of the receptacle 130. In this example, the vacuum contact surface 128 is curved/convex to match the concave/curved nature of the receptacle 130. As further shown, the three-dimensional surface profile of each vacuum contact surface 128 corresponds to a three-dimensional surface profile of a main body portion of a receptacle 130. Each vacuum contact surface 128 therefore has a main body portion 128a to contact the main body portion of a receptacle 130. Given that the receptacles 130 formed in the second mould cavities 118 (which are being carried/transferred by the second transfer device 108) have a lower liquid content than the partially formed receptacles 126 carried by the first transfer device 106, the receptacles 130 have a greater structural integrity, so the shoulder and neck portion of the receptacles 130 do not need to be supported in the same way as for the partially formed receptacles 126.

FIG. 10B depicts a perspective view of part of the second transfer device 108 with receptacles 130 being carried and therefore held against the vacuum contact surfaces 128 via suction.

As with the first transfer device 106, each vacuum contact surface 128 may be removable from the second transfer device 108. For example, each vacuum contact surface 128 may couple with respective holders 142 of the second transfer device 108. Again, this allows different sized/shaped vacuum contact surfaces 128 to be selected and coupled to the holders 142 depending on the type of receptacle being manufactured and thus to be transported by the second transfer device 108.

In some examples, the first and second transfer devices 106, 108 are identical to each other, apart from the form of the vacuum contact surfaces 122, 128 coupled to the holders 142. In a particular example, each the vacuum contact surface 122 of the first transfer device 106 has a first three-dimensional surface profile corresponding to a three-dimensional surface profile of an outer surface of the partially formed receptacle, and each vacuum contact surface 128 of the second transfer device 108 has a second three-dimensional surface profile corresponding to a three-dimensional surface profile of an outer surface of the receptacle 130, and the first three-dimensional surface profile is different to the second three-dimensional surface profile. For example, as already explained, each vacuum contact surface 122 of the first transfer device 106 has a different shape to the vacuum contact surfaces 128 of the second transfer device 108. For example, not only do the vacuum contact surfaces 122, 128, contact different portions of the product being carried, they may also have different curvatures due to the different sizes of the product. For example, thermoforming in the second mould cavities 118 may cause the receptacles 130 to have a different radius of curvature to the partially formed receptacles 126.

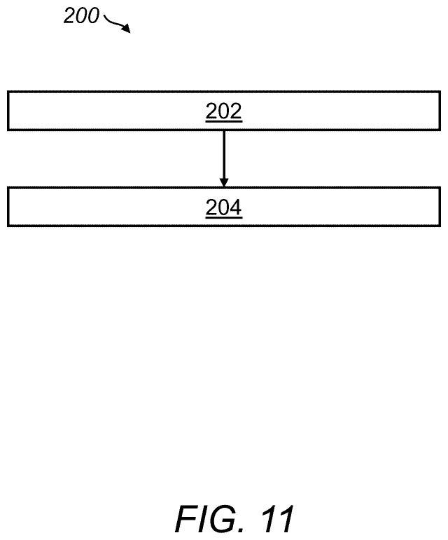

FIG. 11 depicts a first example method 200. In block 202, the method comprises at a first time, simultaneously transferring two or more partially formed hollow moulded fibre products 126 from respective first mould cavities 116 of a plurality of first mould cavities 116 to a first subset 104a of a plurality of second mould cavities 118 using a transfer device 106. In block 204, the method comprises, at a second time, simultaneously transferring two or more further partially formed hollow moulded fibre products 126 from respective first mould cavities 116 of the plurality of first mould cavities 116 to a second subset 104b of the plurality of second mould cavities 118 using the transfer device 106. In examples, the plurality of first mould cavities 116 are configured to receive a fibre suspension for forming respective partially formed hollow moulded fibre products 126 therein, and the plurality of second mould cavities 118 are configured to receive respective partially formed hollow moulded fibre products 126 from the plurality of first mould cavities 116 for further processing the partially formed hollow moulded fibre products 126 in the plurality of second mould cavities 118 to provide hollow moulded fibre products 130. In examples, the total number of the second mould cavities 118 is greater than a total number of the first mould cavities 116. The method may be a method of manufacturing a receptacle, in certain examples. The method can be performed within, or by, the system 100 discussed earlier.

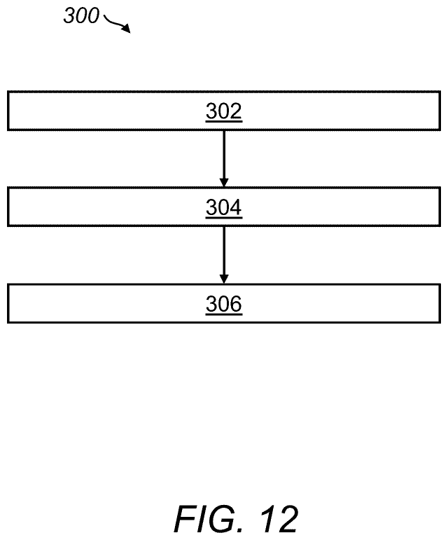

FIG. 12 depicts a second example method 300. In block 302, the method comprises moving a vacuum contact surface 122, 128 of a transfer device 106, 108 towards a product 126, 130 when the product 126, 130 is at a first location (such as the first moulding station 102, the second moulding station 104, a first mould cavity 116 or a second mould cavity 118). The product is a partially formed hollow moulded fibre product 126 or a hollow moulded fibre product 130. The transfer device 106, 108 may therefore move to collect the product 126, 130 from the first location.

In block 304, the method comprises applying a vacuum to the vacuum contact surface 122, 128 to retain the product 126, 130 in contact with the vacuum contact surface 122, 128. In some examples, applying the vacuum causes the product 126, 130 to “jump” from the first location to be in contact with the vacuum contact surface 122, 128. In other examples, the vacuum contact surface 122, 128 may be in contact with the product 126, 130 as the transfer device 106, 108 collects the product 126, 130 from the first location.

In block 306, the method comprises moving the vacuum contact surface 122, 128 relative to the first location while the vacuum is applied to the vacuum contact surface 122, 128 to retain the product 126, 130 in contact with the vacuum contact surface 122, 130, such that the transfer device 106, 108 carries the product 126, 130 towards a second location (such as the second moulding station 104, a second mould cavity 118, or the location 110). For example, the vacuum contact surface 122, 128 may be moved away from the first location, such that the transfer device 106, 108 carries the product 126, 130. The product 126, 130 may be carried to, and in some cases deposited at, the second location. For example, the product 126 may be deposited in a second mould cavity 118 or the product 130 may be deposited on a moving surface, such as the conveyor belt 110. The method may be a method of manufacturing a receptacle, in certain examples. The method can be performed within, or by, the system 100 discussed earlier.

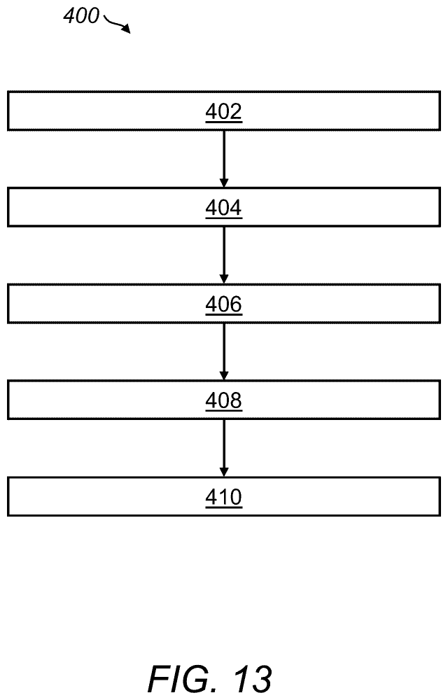

FIG. 13 depicts a third example method 400. In block 402, the method comprises providing a transfer device 106 for transferring a partially formed hollow moulded fibre product 126 from a first mould cavity 116 to a second mould cavity 118 for further processing the partially formed hollow moulded fibre product 126 in the second mould cavity 118 to provide a hollow moulded fibre product 130. In block 404, the method comprises moving a contact surface 122 of the transfer device 106 towards the partially formed hollow moulded fibre product 126 when the partially formed hollow moulded fibre product 126 is in the first mould cavity 116, to collect the partially formed hollow moulded fibre product 126 from the first mould cavity 116. In block 406, the method comprises moving the contact surface 122 of the transfer device 106 away from the first mould cavity 116 to move the partially formed hollow moulded fibre product 126 away from the first mould cavity 118. In block 408, the method comprises, after moving the contact surface 122 of the transfer device 106 away from the first mould cavity 116, obtaining, by an inspection system 124, a state of the partially formed hollow moulded fibre product 126. In block 410, the method comprises performing an action based on the state of the partially formed hollow moulded fibre product 126. The method may be a method of manufacturing a receptacle, in certain examples. The method can be performed within, or by, the system 100 discussed earlier.

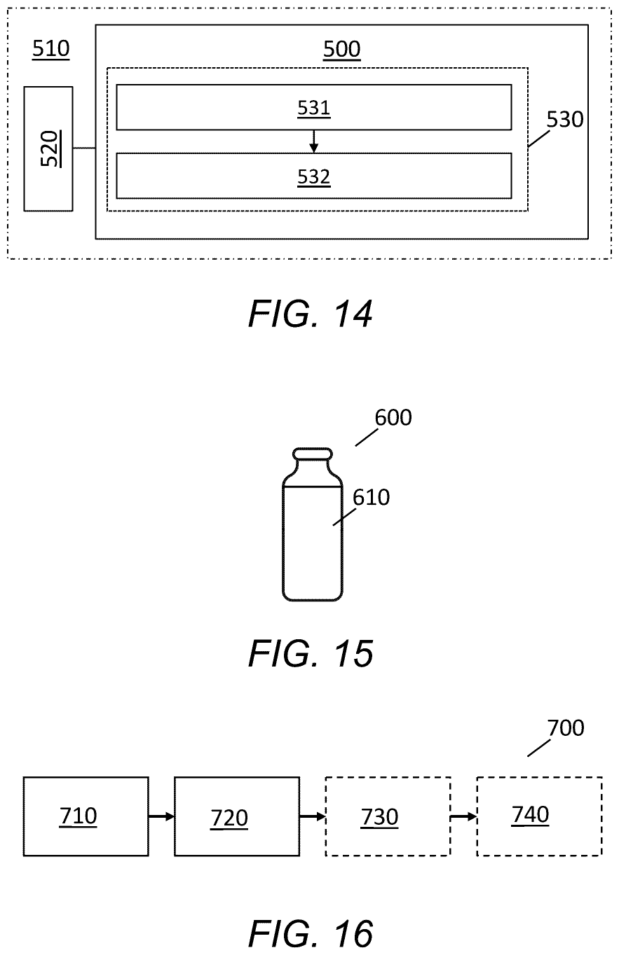

FIG. 14 shows a schematic diagram of a computer-readable storage medium 500 according to an example. In certain examples, the computer-readable storage medium 500 is non-transitory. The computer-readable storage medium 500 stores instructions 530 that, if executed by a hollow-moulded-fibre-product-manufacturing-system controller 520, such as a processor, of a hollow moulded fibre product manufacturing system 510, cause the hollow moulded fibre product manufacturing system 510 to perform a method according to an example. In some examples, the hollow moulded fibre product manufacturing system 510 is or comprises the hollow moulded fibre product manufacturing system 100 described above. The instructions 530 cause the hollow moulded fibre product manufacturing system 510 to at least partially perform the method steps of methods 200, 300 and 400 set out above. Method steps that do not involve an action or control of an element of the system 100, 501 (such as “providing” an element of the system), are not performed by the system, and as such, may not form part of the instructions 530.

It will also be appreciated that there also is provided a receptacle manufacturing line (such as that shown in FIG. 1) comprising the hollow moulded fibre product manufacturing system 100 and apparatus for performing at least one additional process on at least one hollow moulded fibre product 130 to provide a receptacle. Similarly, also provided is a method of manufacturing a receptacle, the method comprising any of methods 200, 300 or 400 to provide hollow moulded fibre products 130, and then performing at least one additional process on at least one of the hollow moulded fibre products 130 to provide the receptacle 130. Examples of the “at least one additional process” are described above with reference to FIG. 1.

Also provided, as a result of the content of the present application, is use of a receptacle obtained by any of the methods described herein to contain contents. An example such receptacle 600, in the form of a receptacle and specifically a bottle, containing contents 610 is shown in FIG. 15. The use could be, for example, by a person who puts the contents into the receptacle, by a person who transports the contents, or by a person who wishes to dispose of (for example, to a consumer or end user), offer to dispose of (for example, to a consumer or end user), import, or keep the contents whether for disposal or otherwise. The contents could, for example, be any one or more of the example contents described herein.

Also provided is a method of providing a content-containing receptacle. An example such method 700 is shown in FIG. 16. The method 700 comprises providing 710 the receptacle, in the form of a receptacle and specifically a bottle, and then providing 720 the contents in the receptacle. In this example, block 720 follows block 710, so that block 720 comprises putting the contents into the receptacle that has been provided at block 710. However, in some other examples, blocks 710 and 720 are performed concurrently, so that the providing 710 the receptacle comprises providing the receptacle with the contents already present in the receptacle. The contents could, for example, be any one or more of the example contents described herein. The method 700 also comprises closing 730 an opening of the receptacle after block 720, and applying 740 a label or indicia to the receptacle after block 730. In this example, block 730 involves applying a heat seal to the opening and then screwing a cap or lid onto the receptacle, and block 740 comprises adhering a label onto the receptacle.

In respective other examples, the order of blocks 730 and 740 is reversed, blocks 730 and 740 are performed concurrently, block 730 is omitted, and block 740 is omitted. In some examples, block 740 occurs before block 720, or block 740 occurs during block 720. For example, in some cases, the label or indicia is applied to the receptacle, then the contents are provided in the receptacle, and then the receptacle is closed.

It will be appreciated that the method 700 could be performed by the same party that manufactures the receptacle, for example so that block 710 comprises the method shown in FIG. 1. Alternatively, the method 700 could be performed by a different party to that which manufactures the receptacle. In such an alternative, the different party performs block 710 by way of obtaining the receptacle from the party that manufactures the receptacle (such as by way of the method shown in FIG. 1) or from an intermediary.

Example embodiments of the present invention have been discussed, with reference to the examples illustrated. However, it will be appreciated that variations and modifications may be made without departing from the scope of the invention as defined by the appended claims.

What is claimed is:

1. A hollow moulded fibre product manufacturing system, comprising:
a plurality of first mould cavities configured to receive a fibre suspension for forming respective partially formed hollow moulded fibre products therein;
a plurality of second mould cavities configured to receive the respective partially formed hollow moulded fibre products from the plurality of first mould cavities for further processing the respective partially formed hollow moulded fibre products in the plurality of second mould cavities to provide hollow moulded fibre products, wherein a total number of the second mould cavities is greater than or equal to a total number of the first mould cavities; and
a transfer device configured to transfer the partially formed hollow moulded fibre products from the plurality of first mould cavities to the plurality of second mould cavities.

2. The manufacturing system of claim 1, wherein the total number of the second mould cavities is greater than the total number of the first mould cavities.

3. The manufacturing system of claim 1, wherein the total number of the second mould cavities is twice the total number of the first mould cavities.

4. The manufacturing system of claim 1, wherein the total number of the second mould cavities is greater than the total number of the first mould cavities and the transfer device is configured to transfer two or more partially formed hollow moulded fibre products from the plurality of first mould cavities to a subset of the plurality of second mould cavities.

5. The manufacturing system of claim 4, wherein the subset is a first subset, and the transfer device is configured to:
transfer two or more partially formed hollow moulded fibre products from the plurality of first mould cavities to the first subset of the plurality of second mould cavities at a first time; and
transfer two or more further partially formed hollow moulded fibre products from the plurality of first mould cavities to a second subset of the plurality of second mould cavities at a second time.

6. The manufacturing system of claim 4, wherein the subset is a first subset, and the transfer device is configured to:
transfer all the partially formed hollow moulded fibre products from the plurality of first mould cavities to the first subset of the plurality of second mould cavities at a first time; and
transfer all of a further plurality of partially formed hollow moulded fibre products from the plurality of first mould cavities to a second subset of the plurality of second mould cavities at a second time.

7. A receptacle manufacturing line comprising the hollow moulded fibre product manufacturing system of claim 1 and apparatus for performing at least one additional process on at least one of the hollow moulded fibre products to provide a receptacle.

8. A method, comprising:
at a first time, simultaneously transferring two or more partially formed hollow moulded fibre products from respective first mould cavities of a plurality of first mould cavities to a first subset of a plurality of second mould cavities using a transfer device; and
at a second time, simultaneously transferring two or more further partially formed hollow moulded fibre products from respective first mould cavities of the plurality of first mould cavities to a second subset of the plurality of second mould cavities using the transfer device;
wherein:
the plurality of first mould cavities is configured to receive a fibre suspension for forming respective partially formed hollow moulded fibre products therein;
the plurality of second mould cavities is configured to receive respective partially formed hollow moulded fibre products from the plurality of first mould cavities for further processing the partially formed hollow moulded fibre products in the plurality of second mould cavities to provide hollow moulded fibre products; and
a total number of the second mould cavities is greater than a total number of the first mould cavities.

9. The method of claim 8, comprising:
at the first time, simultaneously transferring all of a plurality of partially formed hollow moulded fibre products from the plurality of first mould cavities to the first subset of the plurality of second mould cavities using the transfer device; and
at the second time, simultaneously transferring all of a further plurality of partially formed hollow moulded fibre products from the plurality of first mould cavities to the second subset of the plurality of second mould cavities using the transfer device.

10. The method of claim 8, wherein the transfer device comprises two or more vacuum contact surfaces to contact the two or more partially formed hollow moulded fibre products as they are being transferred from the plurality of first mould cavities to the plurality of second mould cavities, the method comprising, at the first time:
(i) moving the two or more vacuum contact surfaces of the transfer device towards the two or more partially formed hollow moulded fibre products within respective first mould cavities of the plurality of first mould cavities;
(ii) applying a vacuum to the two or more vacuum contact surfaces to hold the two or more partially formed hollow moulded fibre products on the two or more vacuum contact surfaces;
(iii) moving the two or more vacuum contact surfaces relative to the plurality of first mould cavities, such that the transfer device carries the two or more partially formed hollow moulded fibre products; and
(iv) depositing the two or more partially formed hollow moulded fibre products in respective second mould cavities of the plurality of second mould cavities.

11. The method of claim 8, comprising:
providing the plurality of first mould cavities, the plurality of first mould cavities being aligned along a first axis;
providing the plurality of second mould cavities, the plurality of second mould cavities being aligned along a second axis;
providing the transfer device, the transfer device being configured to transfer the two or more partially formed hollow moulded fibre products from the plurality of first mould cavities to the plurality of second mould cavities while the two or more partially formed hollow moulded fibre products are aligned along a third axis on the transfer device; and
at both the first and second times, moving the transfer device from a first position in which the third axis is coincident with the first axis, to a second position in which the third axis is coincident with the second axis.

12. The method of claim 8, comprising:
transferring a hollow moulded fibre product from a second mould cavity of the plurality of second mould cavities to a further location using a second transfer device.

13. The method of claim 8, comprising:
after the first time and before the second time, determining that the two or more partially formed hollow moulded fibre products from respective first mould cavities of a plurality of first mould cavities are ready to be transferred to the second subset of the plurality of second mould cavities.

14. The method of claim 8, comprising alternating between transferring two or more partially formed hollow moulded fibre products to the first and second subsets of the plurality of second mould cavities using the transfer device.

15. A hollow-moulded-fibre-product-manufacturing-system controller configured to cause a hollow moulded fibre product manufacturing system to perform the method of claim 8.

16. A non-transitory storage medium storing machine-readable instructions that, when executed by a hollow-moulded-fibre-product-manufacturing-system controller, cause a hollow moulded fibre product manufacturing system to perform the method of claim 8.
